(19) United States
(12) Patent Application Publication
(10) Pub. No.: US 2018/0268372 A1
(43) Pub. Date: Sep. 20, 2018

(54) VISUALIZATION OF MICROFLOWS OR PROCESSES

(71) Applicant: BIPRONUM, INC., Belmont, CA (US)

(72) Inventor: Tim Bussiek, Belmont, CA (US)

(21) Appl. No.: 15/921,520

(22) Filed: Mar. 14, 2018

Related U.S. Application Data
(60) Provisional application No. 62/471,802, filed on Mar. 15, 2017.
(60) Provisional application No. 62/597,773, filed on Dec. 12, 2017.

(51) Int. Cl. G06Q 10/10; G06F 3/0482; G06F 3/0481

(52) U.S. Cl. CPC G06Q 10/103; G06F 3/04815; G06F 3/0482

(57) ABSTRACT

A process management tool (PMT) brings together the functionalities of rigid, system-enforced workflow orchestration and user-driven, task-centric collaboration space. The PMT allows a user to store their work artifact in their preferred repositories or file sharing services. Users share the work artifact via the PMT, which connects an invited participant in a specific role associated with the work artifact. The PMT forms a microflow by creating a context on top of the work artifact relating the work artifact to actions and persons. Microflow templates facilitate existing work practice without requiring time-consuming and expensive integration projects or workflow modeling.

### CROSS-REFERENCE TO RELATED APPLICATION(S)

This application claims the benefit of U.S. Provisional Application Ser. No. 62/471,802 titled “THREE-DIMENSIONAL VISUALIZATION OF PROCESSES” filed Mar. 15, 2017, and U.S. Provisional Application Ser. No. 62/597,773 titled “THREE-DIMENSIONAL VISUALIZATION AND MANAGEMENT OF MICROFLOWS” filed Dec. 12, 2017, all of which are incorporated herein by reference for all purposes in their entirety.

### BACKGROUND

### Web 2.0

One of the key success factors for Web 2.0 is the instrumentation of social networks to create an emerging system of people contributing and interacting by means of a hosted software solution. The term Enterprise 2.0 refers to the concept of applying Web 2.0 technology within the enterprise to support interest-driven communities as well as goal-oriented situational teams.

### Task Management

Task management is a concept in various software products spanning from core enterprise resource planning (ERP) to modern personal information tools. Yet, most of them fall short of supporting the actual work practice of users because traditional workflow models are often highly process-oriented and support routine cognitive tasks. For example, ERP workflow engines may generate tasks that prompt the task owner to upload a document, fill out some form, or approve a step. As with any formalized process, idiosyncratic user needs are not well supported and collaboration between parties is strictly managed or ignored. In most cases, the task is not one simple step, but includes collaboration and processing information beyond that pre-defined workflow. A workflow paradigm which is designed to stay in full control of flow will fall short in supporting unstructured knowledge work in which, by definition, the users will most likely understand the problem and identify the solution.

### Collaboration Tools

Collaboration tools like file sharing (e.g., Box, Dropbox), wikis (e.g., Confluence), and chat (e.g., Slack) facilitate communications and shared resources between collaborating parties, but fail to provide context indicating the task that is to be completed or the party responsible for completing the task. For example, adding a shared resource (e.g., a document for collaboration) to a chat conversation in Slack is not the ideal experience to coordinate work around a work artifact and tasks assigned within Slack are hard to track. On the other hand, setting up formal team with document sharing, team members, and to-dos requires too much upfront investment for short situational collaboration.

### BRIEF DESCRIPTION OF THE DRAWINGS

FIG. 1 is an environment in which the disclosed embodiments can be implemented.

FIG. 2A is a logical view of a microflow, consistent with various embodiments.

FIG. 2B is a logical view of a microflow with role-based users, consistent with various embodiments.

FIG. 3 is a logical view of a microflow for creating a legal contract document, consistent with various embodiments.

FIG. 4 is a logical view of a process having a sequence of microflows, consistent with various embodiments.

FIG. 5 is a block diagram of an example of a context data object associated with a work artifact, consistent with various embodiments.

FIG. 6 is an example screenshot of a GUI displaying a 3D graphical representation of a microflow, consistent with various embodiments.

FIG. 7 is an example screenshot of a GUI displaying a 3D representation of a process, consistent with various embodiments.

FIG. 8 is an example screenshot of a GUI for managing microflows, consistent with various embodiments.

FIG. 9 is another example screenshot of a GUI displaying a 3D representation of a process, consistent with various embodiments.

FIG. 10 is another example screenshot of a GUI displaying a 3D representation of a microflow, consistent with various embodiments.

FIG. 11 is another example screenshot of a GUI displaying a 3D representation of a process, consistent with various embodiments.

FIG. 12A is an example screenshot of a GUI for presenting a 2D representation of a process.

FIG. 12B is an example screenshot of a GUI for presenting a 2D representation of a process.

FIG. 12C is an example screenshot of a GUI for presenting a 2D representation of a process.

FIG. 12D is an example screenshot of a GUI for presenting a 2D representation of a process.

FIG. 13 is a screenshot of a GUI that facilitates management of microflows, consistent with various embodiments.

FIG. 14A is an example screenshot of a GUI for generating a new process, consistent with various embodiments.

FIG. 14B is an example screenshot of a GUI for importing a work artifact from a file sharing service, consistent with various embodiments.

FIG. 14C is an example screenshot of a GUI for adding a microflow to a process, consistent with various embodiments.

FIG. 15A is an example screenshot of a GUI for displaying various metrics associated with a microflow and/or a process, consistent with various embodiments.

FIG. 15B is an example screenshot of a GUI for displaying notifications associated with a microflow and/or a process, consistent with various embodiments.

FIG. 15C is an example screenshot of a GUI having various options for editing a microflow and/or a process, consistent with various embodiments.

FIG. 15D is an example screenshot of a GUI for displaying information associated with a microflow and/or a process, consistent with various embodiments.

FIG. 15E is an example screenshot of a GUI for sharing a microflow and/or a process, consistent with various embodiments.

FIG. 16 is a block diagram illustrating an architecture of the PMT of FIG. 1, consistent with various embodiments.

FIG. 17 is a flow diagram of a process for creating a process, consistent with various embodiments.

FIG. 18 is a flow diagram of a method for generating a graphical representation of a microflow or a process, consistent with various embodiments.

FIG. 19 is a block diagram of a computer system as may be used to implement features of the disclosed embodiments.

### DETAILED DESCRIPTION

Disclosed are embodiments of a process management tool (PMT) that integrates workflow orchestration with user-driven ad-hoc collaboration. The PMT achieves the integration by adding context information to a work artifact indicating the relationship between the work artifact, a user, and a role of the user or an action to be performed by the user. This context information captures the collaborative tasks associated with the work artifact to achieve a desired result.

A work artifact represents a shared resource involving one or more parties (e.g., users). For example, a work artifact may be a shared resource such as an electronic document accessible by multiple parties for collaboration. The work document may be stored in a file sharing service such as Box or Dropbox. The work artifact may be associated with context information indicating parties associated with the work artifact, the status, location, and source of the work artifact. Additionally, the context information may indicate that the work artifact has been approved by a supervisor and that the work artifact originates from a party or organization. Further, contextual information optionally supports coordinative functions such as due dates, reminders, etc.

A microflow models the relationship between a work artifact, a user, and a role or action of the user to facilitate the ad-hoc collaboration emerging based on the needs of a situational task. In some embodiments, a microflow represents a specified collaboration task to be performed by users in association with the work artifact. A user may generate a microflow, e.g., using the PMT, for a specified collaboration task by identifying a work artifact on which the specified collaboration task is to be performed, designating one or more users in association with the work artifact and an action to be performed by the one or more users with the work artifact to achieve the collaboration task. For example, if the specified collaboration task is drafting a document, a microflow may be generated by identifying the document, assigning one or more users to the document, and associating a role or action with the one or more users. Context information is generated and/or updated with information regarding the parties, their roles, and the work artifact when a microflow is generated and/or updated.

Multiple microflows may be linked together to perform multiple collaboration tasks on the work artifact or address a new situation that may arise in an ad-hoc manner. This sequence of microflows may be referred to as a process or journey. In other words, a process is created by associating a work artifact and one or more of the parties across multiple microflows. For example, a legal contract approval process, which involves multiple tasks—drafting the legal contract, reviewing the legal contract, and approving the legal contract—can be modeled or generated as a sequence of microflows. Continuing with the example, a first microflow can be created for drafting the legal contract, which includes sharing the legal contract document from its storage location by a first party, assigning one or more parties to the legal contract, and associating them with a role as “author” for drafting the legal contract. A second microflow may be created for reviewing the legal contract by associating the legal contract with one or more parties and associating the one or more parties with the role of a “reviewer” for reviewing the legal contract. A third microflow may be created for approving the legal contract by assigning or more parties to the legal contract and associating them with a role of an “approver” for approving the legal contract. The work artifact may transition from one microflow to another based on a trigger condition. For example, the legal contract may transition from the first microflow to the second microflow when the status of the first microflow indicates that the drafting of the legal contract is “complete.” In some embodiments, the microflows are considered “linked” if the collaboration tasks that are performed across at least some of the microflows is associated with same work artifact.

The PMT generates a graphical user interface (GUI) that facilitates management of a microflow or a process. In some embodiments, management of the microflow or process includes viewing, creating, updating, modifying, and/or deleting of the microflow or process. The GUI depicts the work artifact, parties potentially involved with the work artifact, and context information indicating the task or process associated with the work artifact. The GUI presents information that allows users to navigate microflows and perform actions associated with the microflows. Specifically, the GUI allows a user to visualize the relationship between the work artifact, the tasks to be completed for the work artifact, and the parties required to engage the tasks. The GUI may depict the status of the work artifact and the progress of the tasks to be completed. The GUI may also generate personalized views on one or more microflows for each party (i.e., user) to indicate the progress of the microflow including which side the action is pending. For example, the GUI may provide a journey view to see what microflows have already been executed. In some embodiments, the GUI includes a dashboard that provides a summary of the process and process statistics. This may include the percentage of microflows completed and which party has completed their actions associated with the microflow.

In some embodiments, the GUI presents a two-dimensional (2D) and/or a three-dimensional (3D) graphical representation of a microflow or a process. For example, the GUI can generate a 3D representation of one or more of the work artifact, storage repositories of the work artifact, the parties, a physical space where the collaboration activities are performed by the parties, e.g., a building, an office space, furniture in the office, etc. The user can access the GUI in various ways, e.g., using gestures, pointer devices.

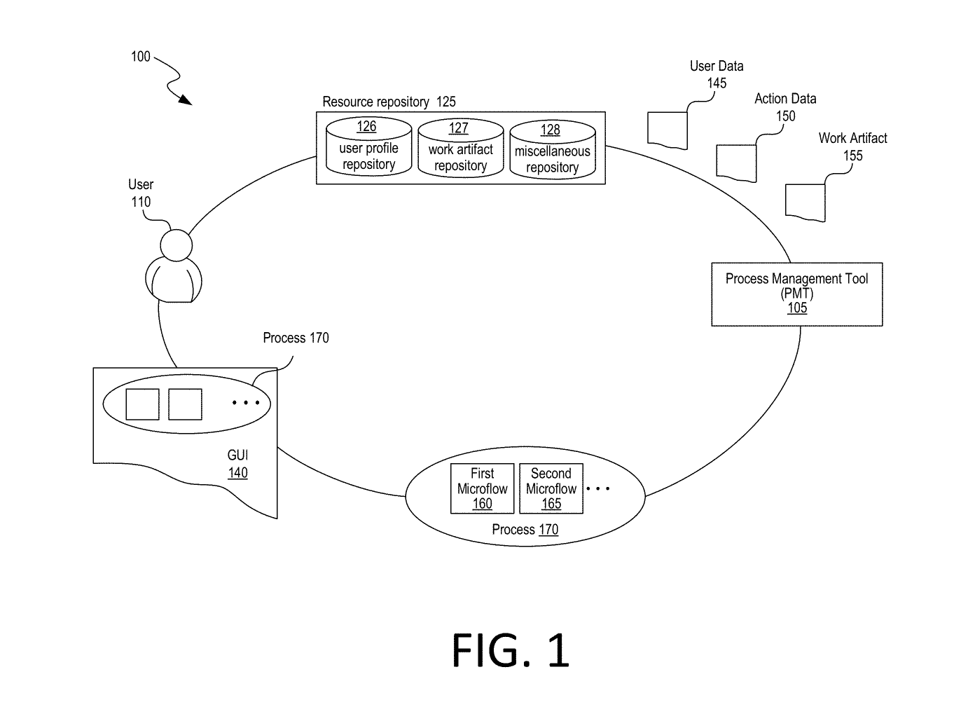

Turning now to figures, FIG. 1 is an environment in which the disclosed embodiments can be implemented. The environment 100 includes a PMT 105 that enables a user 110 to manage microflows. The user 110 can create a microflow by selecting a work artifact 155 on which a collaborative task is to be performed with other users, assigning users to the work artifact 155 and associating each of the users with an action to be performed on the work artifact 155 for the collaborative task. Users or corporations can keep their resources in a resource repository 125, which can be a collection of multiple repositories such as user profile repository 126, work artifact repository 127 and other repositories. The user 110 can select the work artifact 155 from a work artifact repository 127, which can be a remote file storage location or a file sharing service. User data 145 represents the users who are associated with the work artifact 155. The user 110 can choose the users to be assigned to the work artifact 155 from user profile repository 126. Action data 150 represents the action or a role associated with each of the users identified in the user data 145. In some embodiments, the user data 145 and the action data 150 may be combined or generated as a single entity, e.g., as the user data 145 in which data regarding each of the users also includes information regarding a role with which the corresponding user is associated.

The PMT 105 generates a first microflow 160 based on the user data 145, action data 150 and the work artifact 155. The first microflow 160 represents a particular collaborating task to be performed on the work artifact 155. If multiple collaborating tasks are to be performed on the work artifact 155, the user 110 may create multiple such microflows, e.g., like first microflow 160 as described above, for the work artifact and sequence the microflows to form a process 170. For example, if two collaborative tasks such as create document and review document are to be performed for a specified legal contract, the user 110 can create the first microflow 160 for creating the legal contract and a second microflow 165 for reviewing the legal contract. The user 110 can then link the first microflow 160 with the second microflow 165 to form a process 170, e.g., legal contract process. A process 170 may have one or more microflows, and at least in some of the microflows either parties are different or their roles are different.

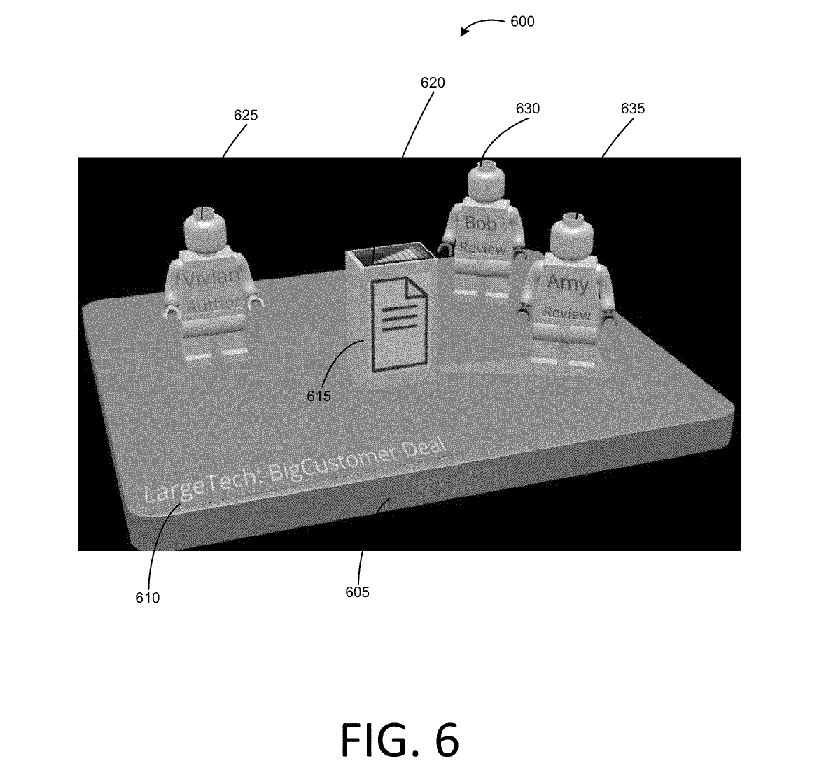

After a microflow is generated, the PMT 105 can send a notification to the users associated with the work artifact 155 regarding the collaborating task to be performed on the work artifact 155. The users may access the work artifact 155 via a GUI 140 generated by the PMT 105. The PMT 105 generates a graphical representation of a microflow and/or the process in the GUI 140. The graphical representation can be a 2D or 3D representation of the microflow and/or the process. Additional details with respect to the graphical representation are described at least with reference to FIGS. 6-15 below.

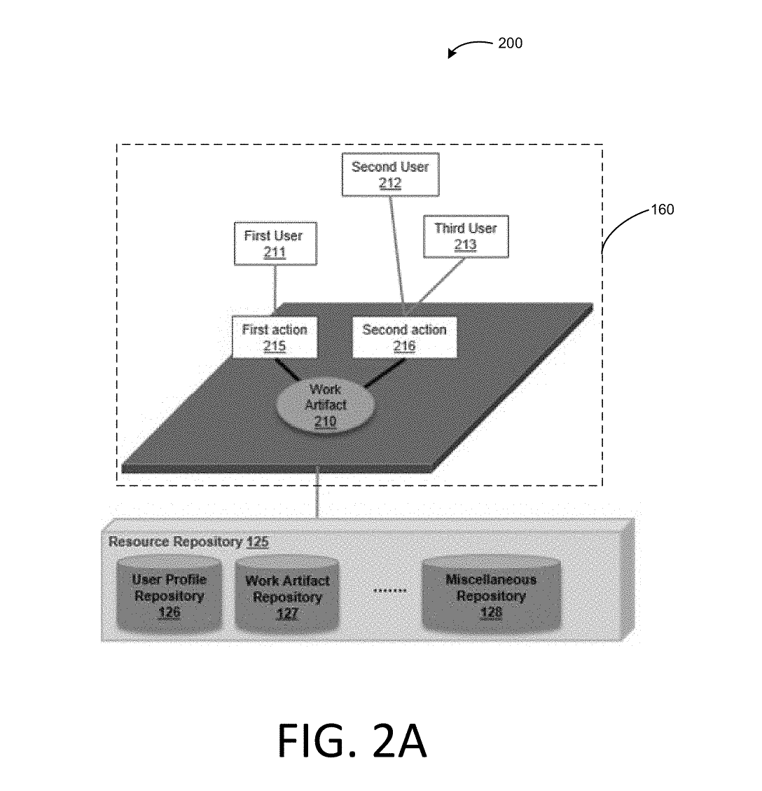

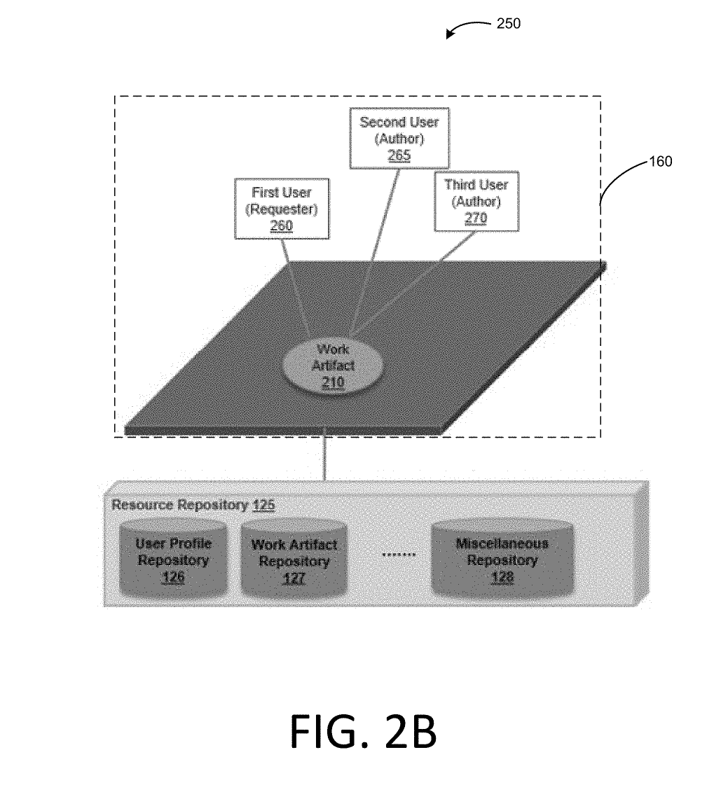

FIG. 2A is a logical view 200 of a first microflow 160, consistent with various embodiments. The first microflow 160 represents a particular collaborative task to be performed on a work artifact 210. In some embodiments, the logical view 200 of the first microflow 160 includes a representation of the users 211-213, actions 215 and 216, and the work artifact 210 associated with the first microflow 160. The work artifact 210 can be similar to the work artifact 155 of FIG. 1 and can be a document requiring the particular collaborative task. The first microflow 160 can have more than one work artifact. The work artifact 210 may be associated with one or more actions, e.g., a first action 215 and a second action 216. The actions 215 and 216 may represent different tasks such as creating a document or approving the document. The actions 215 and 216 are in turn associated with users responsible for completing the action. For example, the first action 215 is associated with a first user 211, and the second action 216 is associated with a second user 212 and a third user 213.

In some embodiments, the actions may not be a separate entity in the microflow. Action data may be combined with the user data. A user may be assigned a role that indicates a particular action to be performed by the user with the respect to the work artifact 210, and the work artifact 210 may be associated with a role-based user in the first microflow 160 instead of the users and actions separately. FIG. 2B is a logical view 250 of the first microflow 160 with role-based users, consistent with various embodiments. In the logical view 250, the work artifact 210 is associated with role-based users. For example, the work artifact 210 is associated with a first user 260 in a first role, e.g., requestor, and with a second user 265 and third user 270 in a second role, e.g., author.

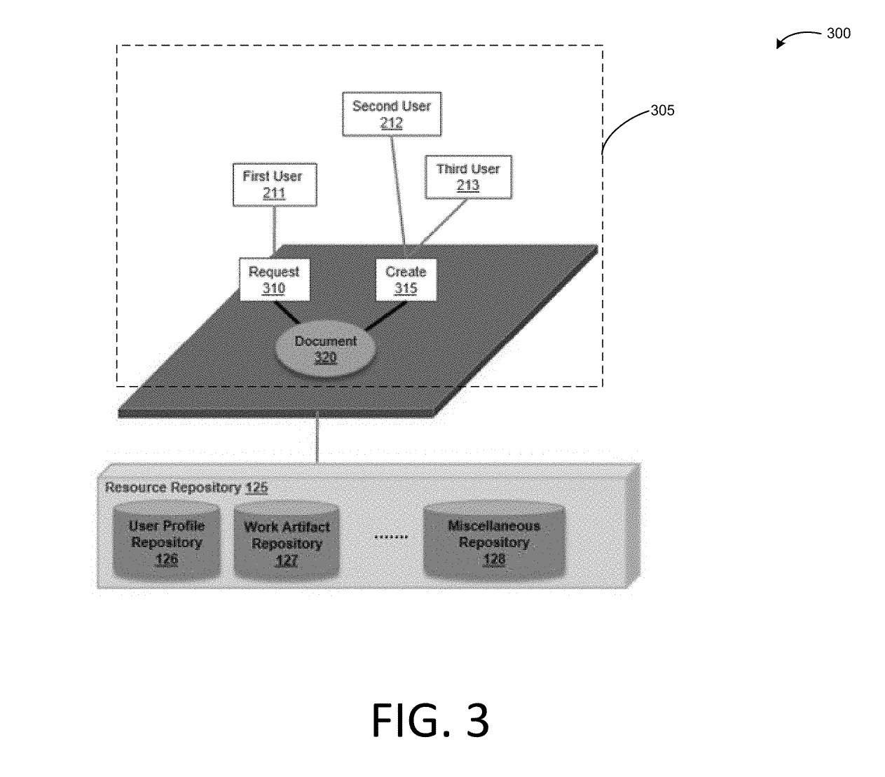

FIG. 3 is a logical view 300 of a microflow 305 for creating a legal contract document, consistent with various embodiments. A first user 211 can initiate the creation of the microflow 305 for a collaborative task, such as creating a legal contract document 320. The first user 211 can then request other users, e.g., the second user 212 and the third user 213 to create or draft the legal contract document 320. Accordingly, the legal contract document 320 is associated with two actions—request action 310 and create action 315. The first user 211, who is requesting the other users to draft the legal contract document 320, is associated with the request action 310, and the second user 212 and the third user 213 who are tasked with drafting the legal contract document 320 are associated with the create action 315.

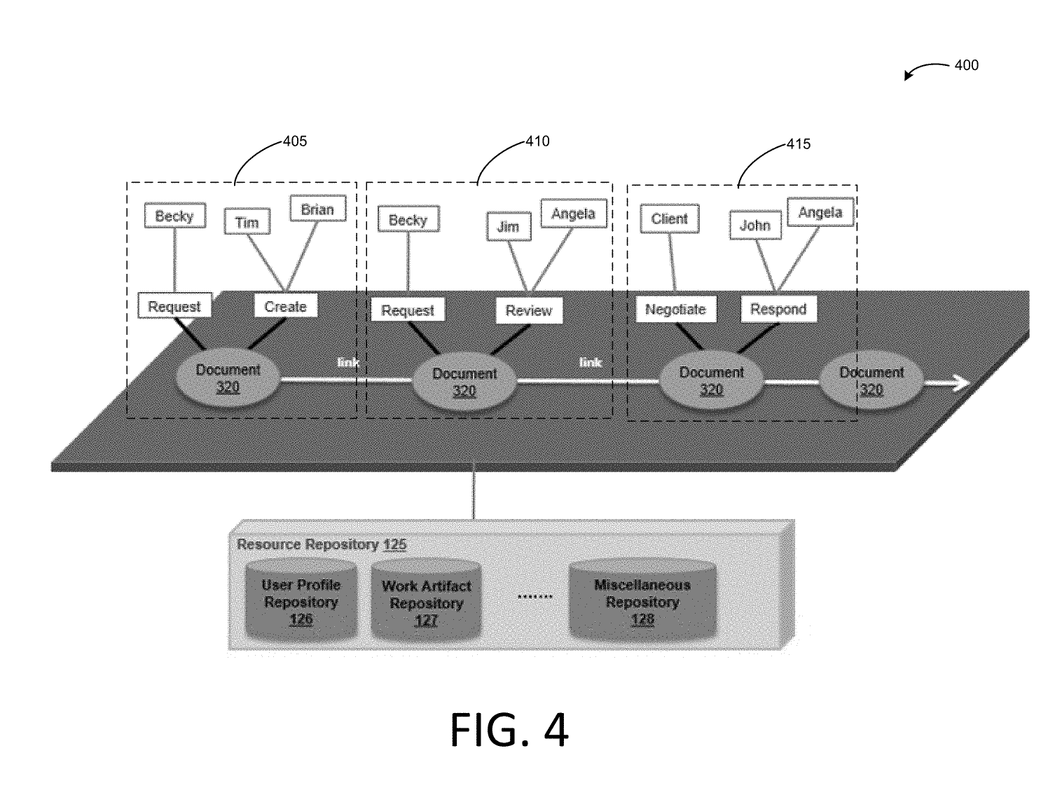

FIG. 4 is a logical view of a process 400 having a sequence of microflows, consistent with various embodiments. Multiple microflows may be linked together to perform multiple collaborative tasks. This sequence of microflows may be referred to as a process, which involves multiple collaboration tasks. In a process or journey each microflow may transition to another microflow. Users can complete a first collaborative task and/or transition to a new microflow while re-using parts of the previous microflow (e.g., copy the shared resource or one or multiple actors). In one embodiment, a work artifact may move or transition from one microflow to another microflow while at least some of the parties of the previous microflow remain associated with the microflow. When microflows are linked together, the sequence of microflows which have some common element is formed.

In some embodiments, the process 400 is a legal contract process, which includes collaborative tasks such as creating a legal contract document 320, reviewing the legal contract document and negotiating the legal contract document 320. In some embodiments, the legal contract document 320 is similar to the work artifact 155 of FIG. 1 or the work artifact 210 of FIG. 2. In some embodiments, an organization such as a law firm can create and review with the legal contract document 320 and then negotiate with a client of the law firm. A party such as a paralegal of the law firm “Becky” can request other members of the law firm, e.g., a first lawyer “Tim” and a second lawyer “Brian” to create the legal contract document 320; a counsel at the law firm “Jim” and a partner at the law firm “Angela” to review the legal contract document 320, and have “Angela” and another partner at the law firm “John” negotiate with the client on the legal contract document 320. Becky can create multiple microflows, one each for creating the legal contract document 320, reviewing the legal contract document 320 and negotiating the legal contract document 320. For example, Becky can create a first microflow 405 that represents creating the legal contract document 320. In the first microflow 405, the legal contract document 320 is associated with two actions—request and create, associating the request action with Becky and the create action with Tim and Brian. A second microflow 410 is created by associating the legal contract document 320 with two actions—request and review, associating the request action with Becky and the review action with Tim and Brian. A third microflow 415 is created by associating the legal contract document 320 with two actions—negotiate and respond, associating the negotiate action with a customer and the respond action with John and Angela. The three microflows are linked to form the process 400. In some embodiments, the common element between the microflows is the legal contract document 320 and some users, e.g., Becky and Angela, across some microflows.

In the process 400 a microflow (e.g., create) may transition to another microflow (e.g., review). Each of the microflows may be associated with a status indicator, which indicates the status of the corresponding microflow. The legal contract document 320 may transition from one microflow to another microflow base on the status indicator. For example, in the first microflow 405 when Tim and Brian indicate that they have completed drafting the legal contract document 320, the status indicator of the first microflow 405 is updated to “complete,” and a notification is sent to users associated with the second microflow 410 to perform the review of the legal contract document 320. Similarly, when Jim and Angela indicate that they have completed reviewing the legal contract document 320, the status indicator of the second microflow 410 is updated to “complete,” and a notification is sent to users associated with the third microflow 415 to negotiate the legal contract document 320 with the customer.

Note that the order of microflows in the process 400 can be changed anytime and in an ad-hoc manner and/or microflows may be added, deleted, or modified in an ad-hoc manner.

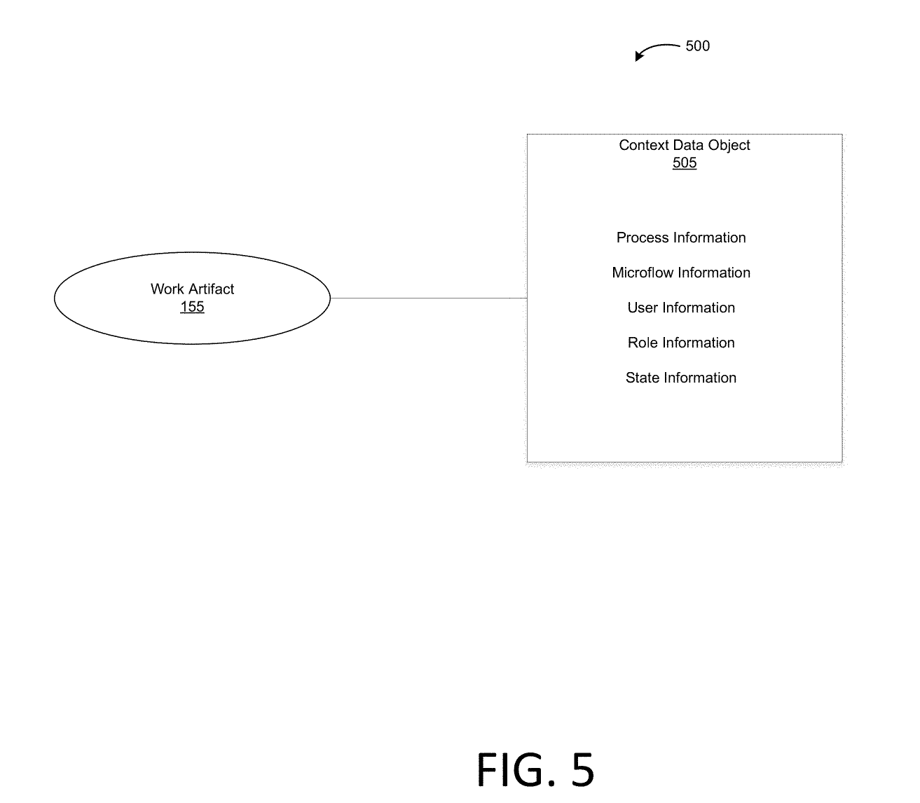

In some embodiments, information associated with the microflows and/or the process is stored as a context data object in association with a work artifact, which can provide a variety of contextual information regarding the work artifact. FIG. 5 is a block diagram of an example 500 of a context data object 505 associated with a work artifact, consistent with various embodiments. The context data object 505 contains context information associated with the work artifact 155 such as microflows associated with the work artifact 155, processes associated with work artifact 155, parties associated with the work artifact 155 for a microflow or a process, the status of the work artifact 155 in a microflow or a process, a storage location of the work artifact 155, a type of the work artifact (e.g., Microsoft Word document, a spreadsheet, or a Microsoft PowerPoint presentation) a source of the work artifact 155, e.g., originates from within an organization or from outside of the organization. The context information indicates the relationship between the work artifact 155, a user, and a role of the user or an action to be performed by the user. More specifically, the context information provides more contextual knowledge on who is doing what, whether an action has been completed or role fulfilled, typical additional roles associated with an existing role.

The context information may also include individual steps and states associated with actions or parties. For example, the steps may indicate the incremental task or tasks that must be taken to complete a microflow action. Similarly, the states may indicate whether the steps have been completed or a level of progress towards completion of the action. Contextual information may also support coordinative functions such as due dates, reminders, start and end dates of a microflow or a process, etc. The context information may be used to initiate communication between parties or create calendar events for tasks associated with the microflow. For example, the information regarding the parties associated with the microflow may be presented to a user or used to automatically initiate a communication between the parties. The information regarding the parties may also be used to generate calendar events that are sent to the parties. Alternatively, the calendar events may be automatically added to the parties' calendars. In one embodiment, the entire microflow information is contained in the context data object 505 and then the context data object 505 is stored in association with the work artifact 155 that may originally reside in another repository. For example, while the work artifact 155 is stored in a file sharing service, (e.g., Box or Dropbox), the context data object 505 may be stored in the miscellaneous repository 128.

With reference to the process 400 of FIG. 4, the context data object 505 associated with the legal contract document 320 may have contextual information that indicates that the legal contract document 320 is associated with a create microflow (first microflow 405), review microflow (second microflow 410) and the negotiate microflow (third microflow 415) and a legal contract document process 400. The context information can also indicate the users participating in each microflow and their associated roles or actions. The context information indicates the relationship between the legal contract document 320, the tasks associated with the legal contract document 320 (e.g., creating, reviewing, and negotiating), and the parties involved (e.g., the paralegal, lawyers, partners, and client).

The PMT 105 also generates a GUI that facilitates management of a microflow or a process. In some embodiments, management of the microflow or process includes viewing, creating, updating, modifying, and/or deleting of the microflow or process. The following paragraphs describe at least some of the features of the GUI.

FIG. 6 is an example screenshot of a GUI 600 displaying a 3D graphical representation of a microflow, consistent with various embodiments. The GUI 600 has a virtual 3D representation of a “create document” microflow 605. The create document microflow 605 is for performing a collaborating task such as creating a work artifact 615, e.g., a document. In some embodiments, the GUI 600 is generated by the PMT 105, and the work artifact 615 is similar to the work artifact 155 of FIG. 1. In the create document microflow 605, the users “Vivian,” “Bob” and “Amy” are associated with the document. Vivian is associated with the document in the role of an author, and Bob and Amy are associated in the role of a reviewer. In the 3D representation of the create document microflow 605, the GUI 600 generates a 3D representation of the work artifact 615, a 3D representation of the author user Vivian 625, a 3D representation of the review user Bob 630, and a 3D representation of the review user Amy 635. The GUI 600 also presents the name of a process 610—“LargeTech: Big Customer Deal” of which the create document microflow 605 is a part.

The GUI 600 also generates a 3D representation of a status indicator 620 that indicates a status of the create document microflow 605. The status indicator 620 can take various forms. For example, the status indicator can have user-defined values such as “Not started,” which indicates that the authors have not started drafting the document yet, “in Progress,” which indicates that the document creation is under progress, and “Complete” which indicates that the document creation is complete. In another example, the status indicator can be a progress level indicator, which indicates the progress of the create document microflow 605. The status indicator 620 is a progress bar that becomes filled as progress is made. For example, the create document microflow 605 requires input from three users—one author and two reviewers. When the author submits their work, the progress bar will be one-third filled. When the first reviewer submits their work, the progress bar will increase to be two-thirds filled. When the second reviewer submits their work, the progress will be fully filled indicating that the create document microflow 605 is completed. A person skilled in the art will understand that other visual representations may be used to indicate the status, progress, or completion of the microflow.

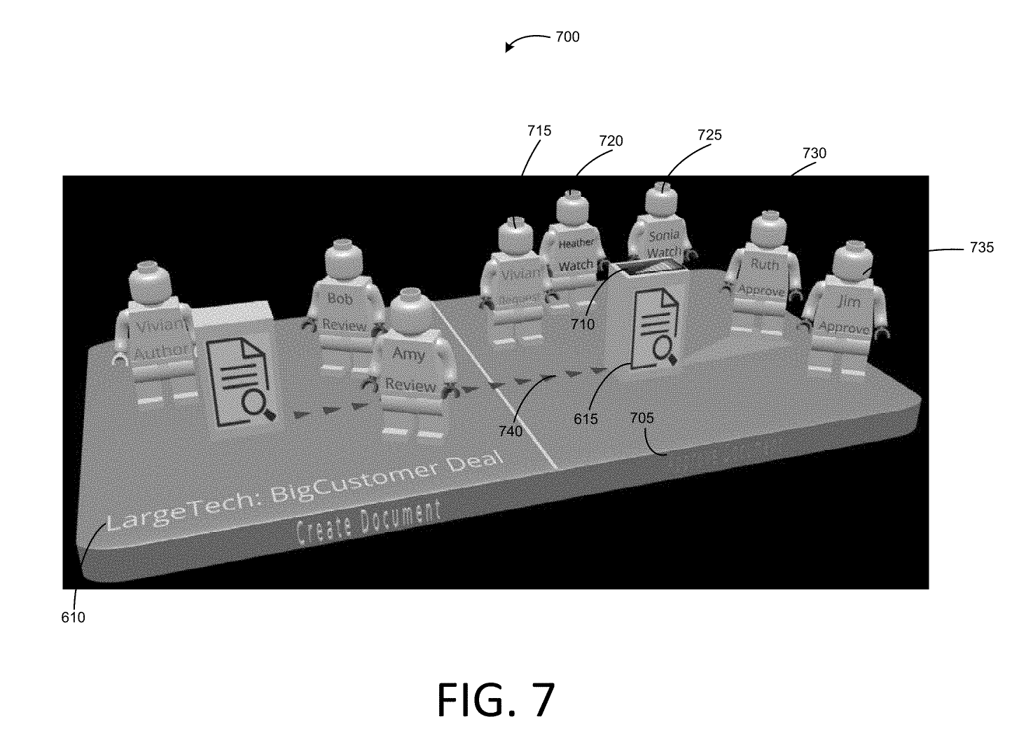

FIG. 7 is an example screenshot of a GUI 700 displaying a 3D representation of a process, consistent with various embodiments. In some embodiments, the GUI 700 is generated by the PMT 105 of FIG. 1. The GUI 700 shows a 3D representation of the process 610 of FIG. 6. The process 610 in the GUI 700 includes two microflows—create document microflow 605, and an “approve document” microflow 705 for a collaborating task such as approving the work artifact 615 that is created in the create document microflow 605. In the approve document microflow 705 the users “Vivian,” “Heather,” “Sonia,” “Ruth” and “Jim” are associated with the work artifact 615. Vivian is associated with the work artifact 615 in the role of a “request” who requests other users to approve the work artifact 615, Heather and Sonia are associated in the role of a “watch” who watch over or are kept informed about the approve process, and Ruth and Jim are associated in the role of an “approve” who approve the work artifact 615. In the 3D representation of the approve document microflow 705, the GUI 700 generates a 3D representation of the work artifact 615, a 3D representation of the request user Vivian 715, a 3D representation of the watch users Heather 720 and Sonia 725, and a 3D representation of the approve users Ruth 730 and Jim 735.

The process 610 transitions from create document microflow 605 to approve document microflow 705, e.g., when the status indicator 620 indicates that the create document microflow 605 has completed. The transition between microflows in the process 610 may be indicated by an arrow 740 connecting the 3D representation of the work artifacts in the microflows. In some embodiments, the work artifact and/or one or more users transition from one microflow to another microflow. In the process 610, the work artifact 615 and user Vivian transition from the create document microflow 605 to the approve document microflow 705. The GUI 700 may indicate the progress of each microflow. The GUI 700 also has a 3D representation of a status indicator 710, which indicates the status of the approve document microflow 605.

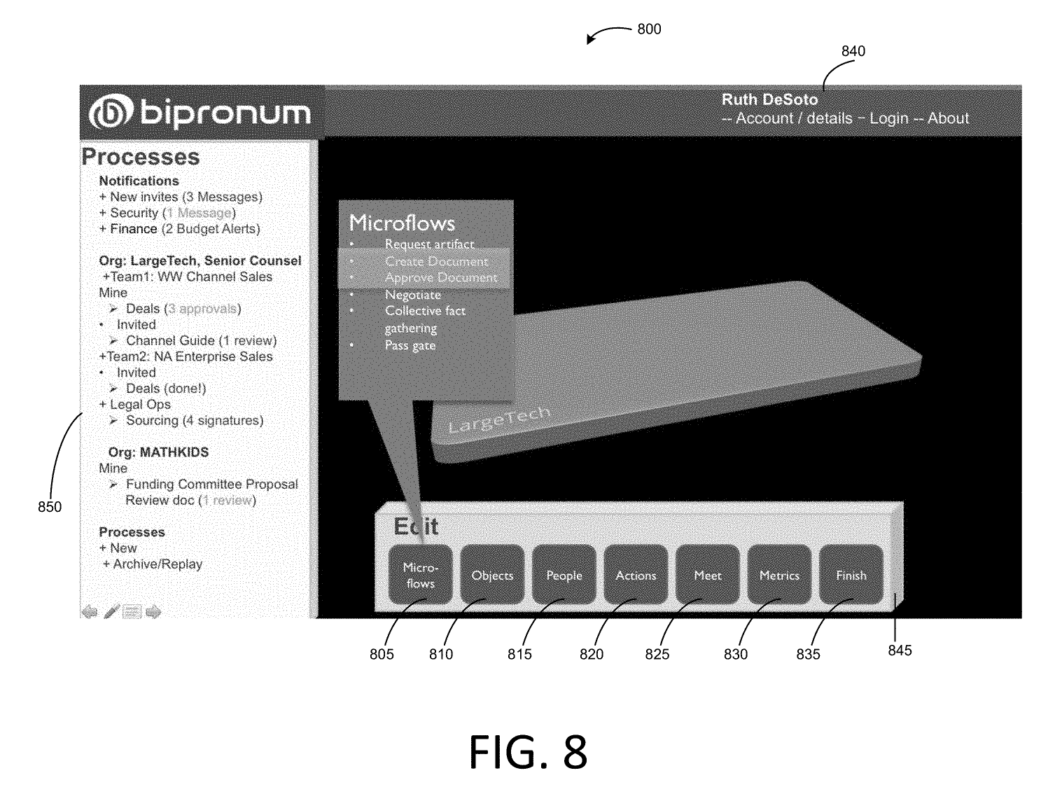

FIG. 8 is an example screenshot of a GUI 800 generated by the PMT 105 for managing microflows, consistent with various embodiments. The GUI 800 provides a representation of various aspects of a microflow or a process. For example, information indicating the user is listed on a first portion 840 of the GUI. The information may include the name of the user and options to view the user's account details and login information. In a second portion 850 of the GUI 800, the GUI 800 lists the processes saved in the PMT 105. In some embodiments, the processes may be grouped based on the client. For example, all the processes for the client “Org: LargeTech, Senior Counsel” are grouped under the corresponding client name. The processes may include information indicating notifications, organizations, and processes. Under notifications, users may view new invitations for performing a collaborative task in a microflow. Under organization, users may view processes organized by teams. Deals associated with each team may also be listed. Users may also be able to create new processes, archive old processes, or replay existing processes.

In an edit interface 845 of the GUI 800, users can select various options related to microflows, objects (e.g., work artifacts), people, actions, meetings, metrics, and exit (e.g., “finish”) the edit interface. Under the microflow interface 805, users may generate a new microflow or modify an existing microflow by selecting one of the microflows. Using the objects interface 810, a user may select the work artifact to be associated with a microflow. Using the people interface 815, a user may select the users to be associated with a microflow. Using the actions interface 820, a user may select an action to be associated with a work artifact in a microflow. Using the meet interface 825, a user may generate calendar invitations to meet with other users associated with the work artifact in a microflow. Using the metrics interface 830, a user may view various metrics associated with a microflow or a process, e.g., number of users in a microflow, a duration for which the microflow was under execution, number of times the microflow was executed, a duration spent by a user in a microflow or a process. Using the finish interface 835, a user may save a microflow or a process and/or exit the GUI 800. A person skilled in the art will understand that the various elements and options described may be arranged in different portions of the screen. Additionally, the GUI 800 may allow the user to rearrange the various elements and options for improved usability.

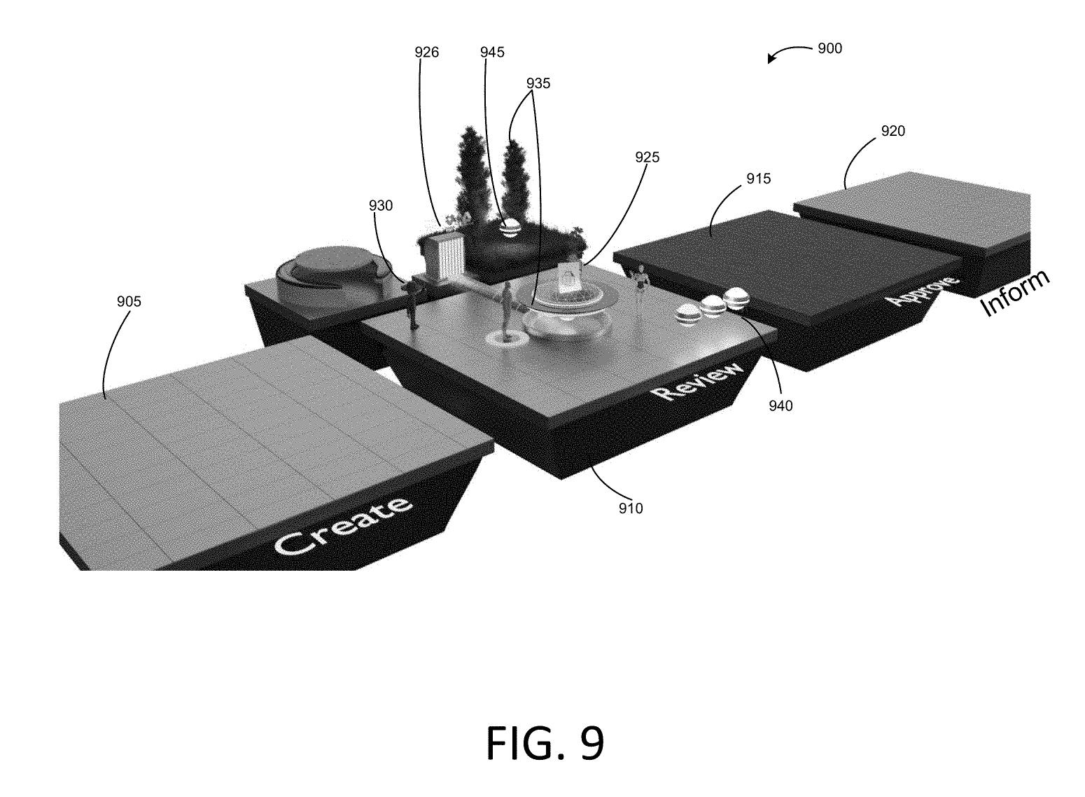

FIG. 9 is another example screenshot of a GUI 900 displaying a 3D representation of a process, consistent with various embodiments. In some embodiments, the GUI 900 is generated by the PMT 105 of FIG. 1. The GUI 900 shows a 3D representation of the process having four microflows—create microflow 905, review microflow 910, approve microflow 915 and inform microflow 920—for performing a set of collaboration tasks associated with a work artifact 925, e.g., a PDF document. The user may select one or more microflows in the GUI 900 and the GUI 900 shows additional details regarding the selected microflows. In GUI 900, a user has selected the review microflow 910 for viewing details regarding the review microflow 910. In the 3D representation of the review microflow 910, the GUI 900 generates a 3D representation of the work artifact 925, a 3D representation of a source 926 of the work artifact 925 (e.g., Google Drive and Dropbox file storage services), a 3D representation of the users 930, and a 3D representation of a physical space 935 (e.g., floor of a building, trees, a desk on which the work artifact 925 is placed) in which the review microflow 910 is performed. In some embodiments, users of different roles may be represented differently to easily identify the roles of the users.

In some embodiments, the GUI 900 depicts whether or not a user associated with a particular microflow is present in his/her office and use that information for a variety of purposes. For example, if the user is present, a meeting request can be sent to the users by selecting the 3D representation of the user from the GUI 900. In some embodiments, the PMT 105 can determine a location of the user in an office by identifying a Wi-Fi hotspot with which the user's mobile device is communicating, RFID tags associated with the user, IoT capabilities, etc. The GUI 900 may also show the location of the user in the 3D representation of the physical space.

In some embodiments, the user may initiate a meeting request by moving the 3D graphical representation of the work artifact 925 to a 3D graphical representation of the desk in the GUI 900 and selecting one or more users from the 3D representations of the users 930 for inviting them to the meeting.

The GUI 900 also shows a 3D representation of the status indicator 940 of the review microflow 910, which indicates the status of the review microflow 910. For example, if the status indicator 940 shows a green light, it indicates that the review microflow 910 is yet to begin. If the status indicator 940 shows an orange light, it indicates that the review microflow 910 is in progress. If the status indicator 940 shows a red light, it indicates that the review microflow 910 is completed. Other representations or indications of the status indicator may be implemented to indicate the status of the microflow accordingly. In some embodiments, a microflow may be associated with two status indicators—a first status indicator that indicates whether a collaboration task associated with the microflow is completed or not and a second status indicator that indicates a level of progress of the microflow. For example, a microflow status indicator 945 can indicate whether the review of the work artifact 925 in the review microflow 910 is completed or not, and the status indicator 940 can be a progress level indicator, like the status indicator 620 of FIG. 6, which indicates a level of progress in reviewing the work artifact 925.

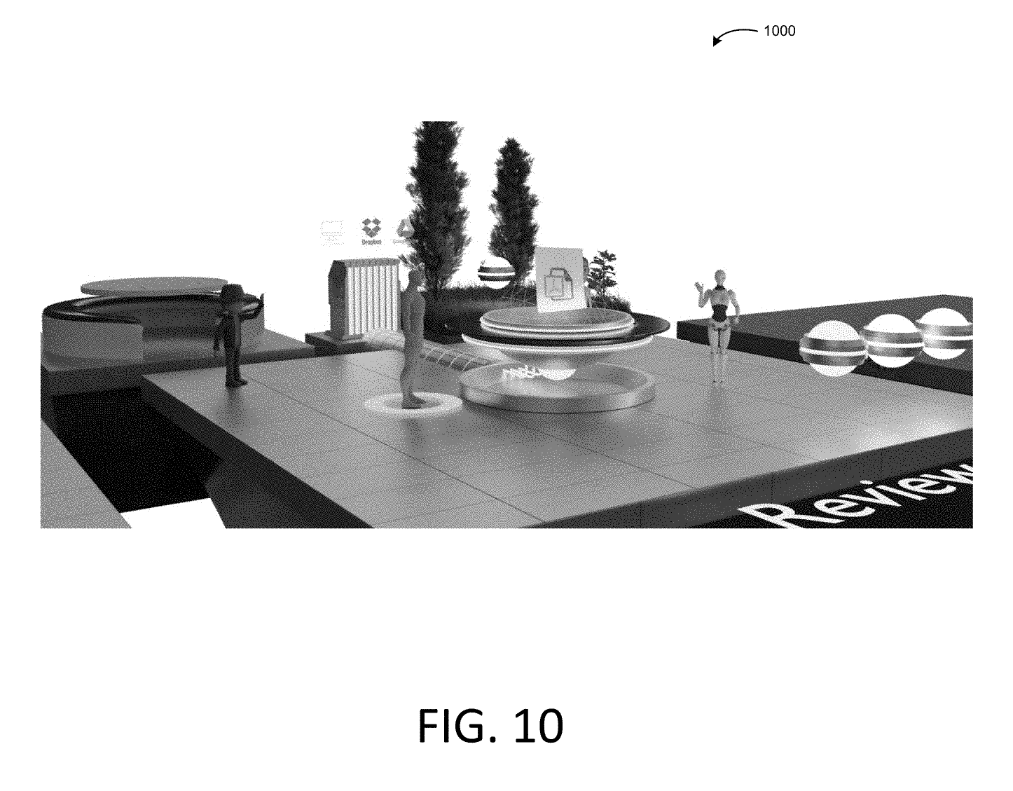

FIG. 10 is another example screenshot of a GUI 1000 displaying a 3D representation of a microflow, consistent with various embodiments. In some embodiments, the GUI 1000 is generated by the PMT 105 of FIG. 1. The GUI 1000 shows a 3D representation of the review microflow 910 of FIG. 9 in a different 3D perspective.

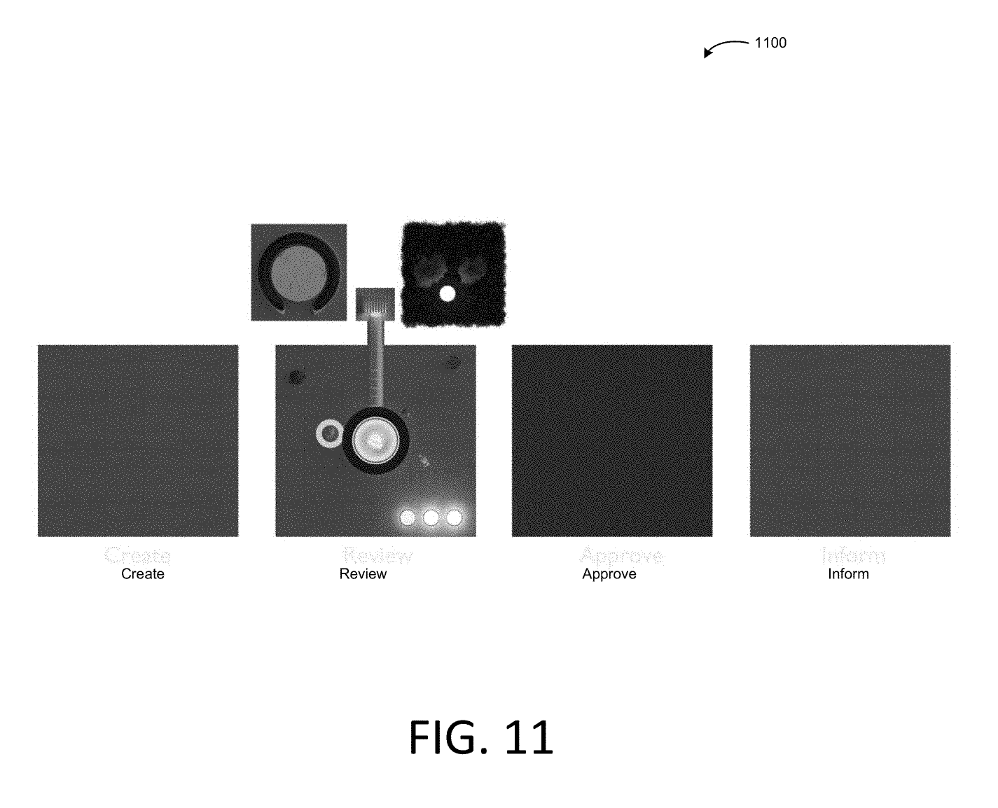

FIG. 11 is another example screenshot of a GUI 1100 displaying a 3D representation of a process, consistent with various embodiments. In some embodiments, the GUI 1100 is generated by the PMT 105 of FIG. 1. The GUI 1100 shows a 3D representation of the process of FIG. 9 in a different 3D perspective.

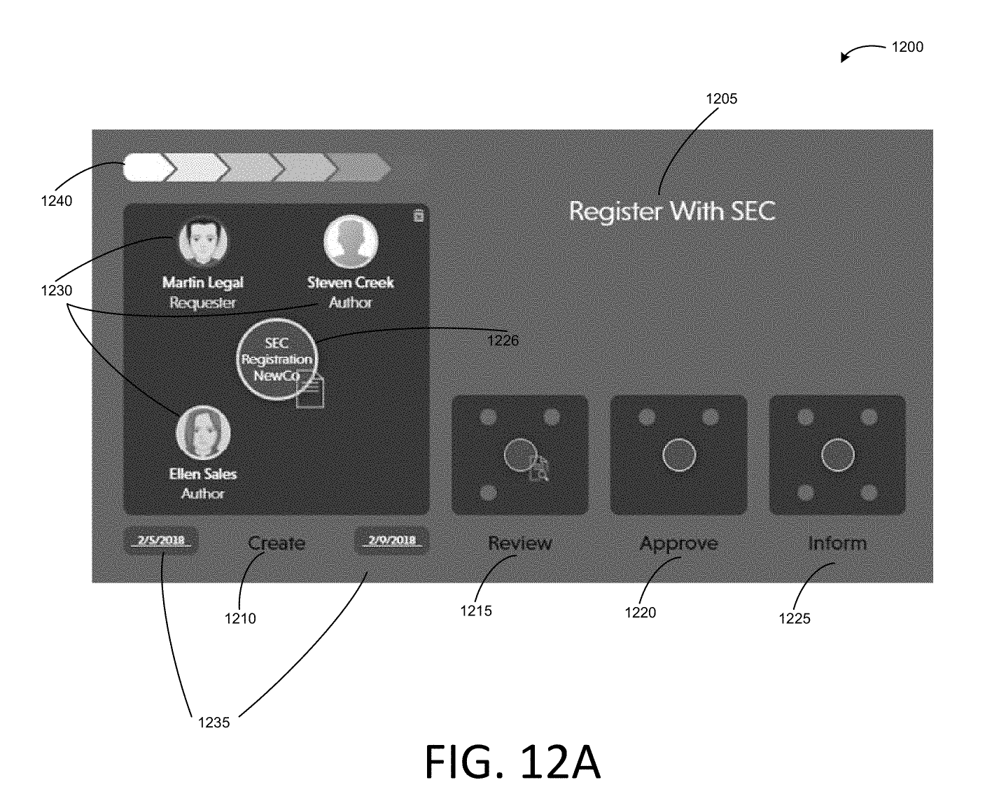

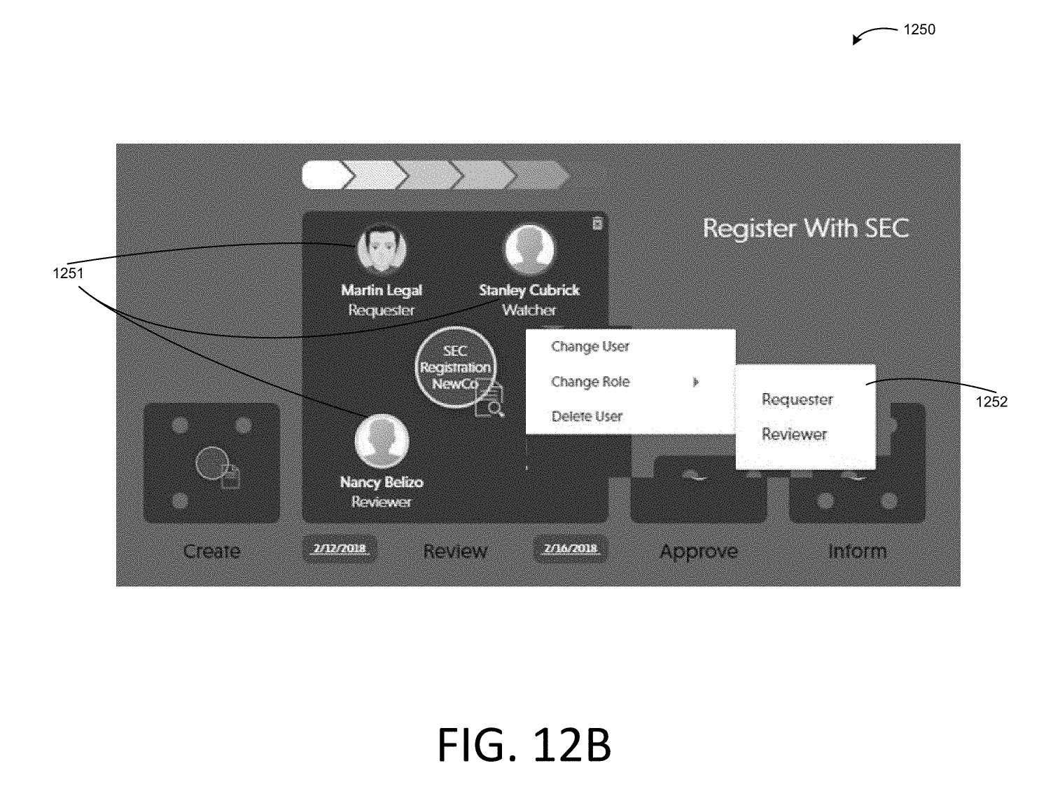

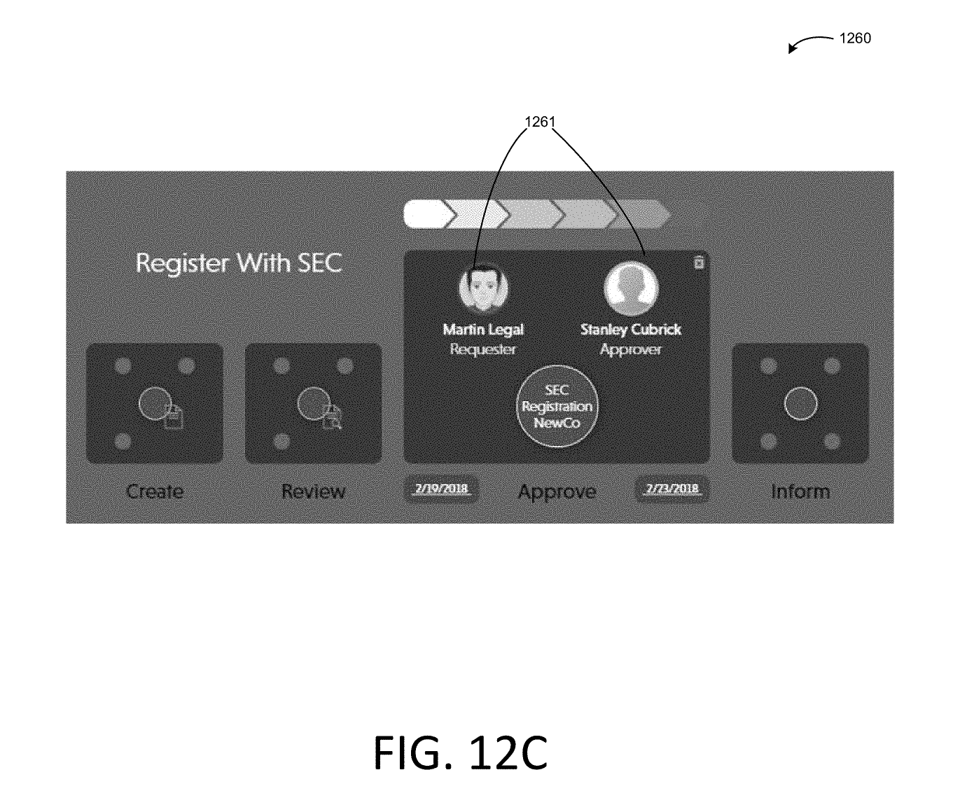

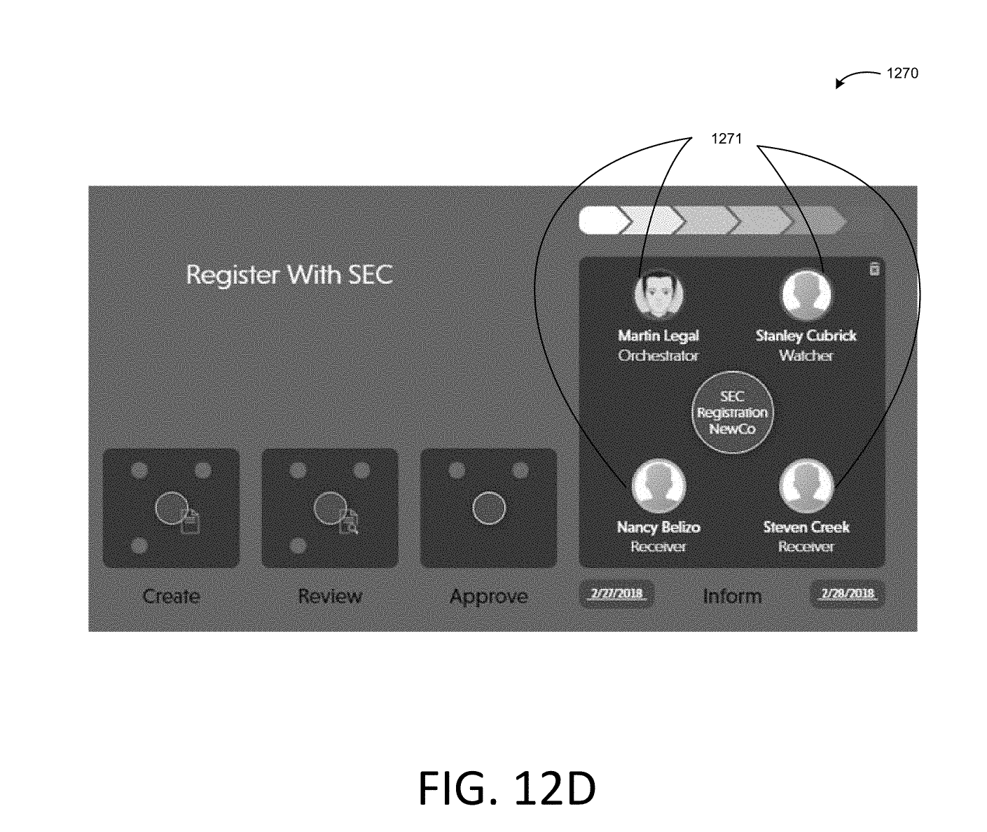

FIGS. 12A-12D are example screenshots of GUIs that are generated by the PMT 105 of FIG. 1 for presenting a 2D representation of microflows of a process. While the GUIs of FIGS. 12A-12D are used to view information regarding the microflows or a process, they can also be used to manage the microflows or a process.

FIG. 12A is an example screenshot of a GUI 1200 for presenting a 2D representation of a process 1205. The process 1205—“Register with SEC” is a process for registering a business entity with a government agency. The process 1205 includes four microflows—create microflow 1210, review microflow 1215, approve microflow 1220 and inform microflow 1225—for performing a set of collaboration tasks associated with a work artifact 1226, e.g., business entity registration document. In some embodiments, the work artifact 1226 is similar to the work artifact 155 of FIG. 1. The create microflow 1210 corresponds to creating the work artifact 1226, review microflow 1215 corresponds to reviewing the work artifact 1226, approve microflow 1220 corresponds to approving the work artifact 1226, and inform microflow 1225 corresponds to sending the work artifact 1226 to a party, e.g., the client of an organization that is providing the registration service. The user may select one or more microflows in the GUI 1200 and the GUI 1200 shows additional details regarding the selected microflows. In GUI 1200, a user has selected the create microflow 1210 for viewing details regarding the create microflow 1210. In the 2D representation of the create microflow 1210, the GUI 1200 generates a 2D representation of the work artifact 1226 and a 2D representation of the users 1230 associated with the create microflow 1210. In some embodiments, users of different roles may be represented differently to easily identify the roles of the users.

In the create microflow 1210, the users “Martin,” “Steven” and “Ellen” are associated with the work artifact 1226. Martin is associated with the work artifact 1226 in the role of a requester who requests other parties (e.g., Steven and Ellen) to create the work artifact 1226, and Steven and Ellen are associated in the role of an author who are tasked with creating the work artifact 1226. The GUI 1200 also presents the name of a process 1205—“Register with SEC” in a portion of the GUI 1200.

The GUI 1200 also shows a date 1235, e.g., a start date and an end date, associated with the create microflow 1210. The GUI 1200 also generates a 2D representation of a status indicator 1240 that indicates a status of the create microflow 1210. The status indicator 620 can take various forms, e.g., as described at least in association with the status indicator 620 of FIG. 6. The process 1205 can transition from a first microflow to a second microflow, e.g., when the status indicator indicates that the first microflow is completed. With reference to the process 1205, the process 1205 can transition from the create microflow 1210 to the review microflow 1215 when the create microflow 1210 is complete, from the review microflow 1215 to the approve microflow 1220 when the review microflow 1215 is complete, from the approve microflow 1220 to the inform microflow 1225 when the approve microflow 1220 is complete, and the process 1205 is considered completed when the inform microflow 1225 is complete.

In some embodiments, a process can transition back to the first microflow from the second microflow. For example, the process 1205 can transition back to the create microflow 1210 from the review microflow 1215 if the reviewers indicate that the work artifact 1226 needs further work from the authors.

FIG. 12B is an example screenshot of a GUI 1250 for presenting a 2D representation of the process 1205. The GUI 1250 illustrates a 2D representation of the review microflow 1215 of the process 1205. In the 2D representation of the review microflow 1215, the GUI 1250 generates a 2D representation of the work artifact 1226 and a 2D representation of the users 1251 associated with the review microflow 1215.

In the review microflow 1215, the users “Martin,” “Stanley” and “Nancy” are associated with the work artifact 1226. Martin is associated with the work artifact 1226 in the role of a requester who requests other parties (e.g., Nancy) to review the work artifact 1226, Nancy in the role of a reviewer who reviews the work artifact 1226, and Stanley in the role of a watcher who watches or supervises the review task.

The GUI 1250 also lets a user, e.g., Martin, to add, remove or change a user and/or set the role of a user, e.g., using the menu 1252. Such menu may be accessible from any of the microflows, e.g., by selecting a user, in the process 1205.

FIG. 12C is an example screenshot of a GUI 1260 for presenting a 2D representation of the process 1205. The GUI 1250 illustrates a 2D representation of the approve microflow 1220 of the process 1205. In the 2D representation of the approve microflow 1220, the GUI 1260 generates a 2D representation of the work artifact 1226 and a 2D representation of the users 1261 associated with the approve microflow 1220.

In the approve microflow 1220, the users “Martin” and “Stanley” are associated with the work artifact 1226. Martin is associated with the work artifact 1226 in the role of a requester who requests other parties (e.g., Stanley) to approve the work artifact 1226, and Stanley in the role of an approver who approves the work artifact 1226.

FIG. 12D is an example screenshot of a GUI 1270 for presenting a 2D representation of the process 1205. The GUI 1270 illustrates a 2D representation of the inform microflow 1225 of the process 1205. In the 2D representation of the inform microflow 1225, the GUI 1270 generates a 2D representation of the work artifact 1226 and a 2D representation of the users 1271 associated with the work artifact 1226 in the inform microflow 1225.

In the inform microflow 1225, the user “Martin” is an orchestrator who coordinates sending the work artifact 1226 to receivers, “Stanley” is a watcher, and Nancy and Steven are receivers who receive the approved work artifact 1226 from the orchestrator.

In some embodiments, at least some of the features, e.g., the start date and end date and the status indicators, can be present across the microflows of the process 1205.

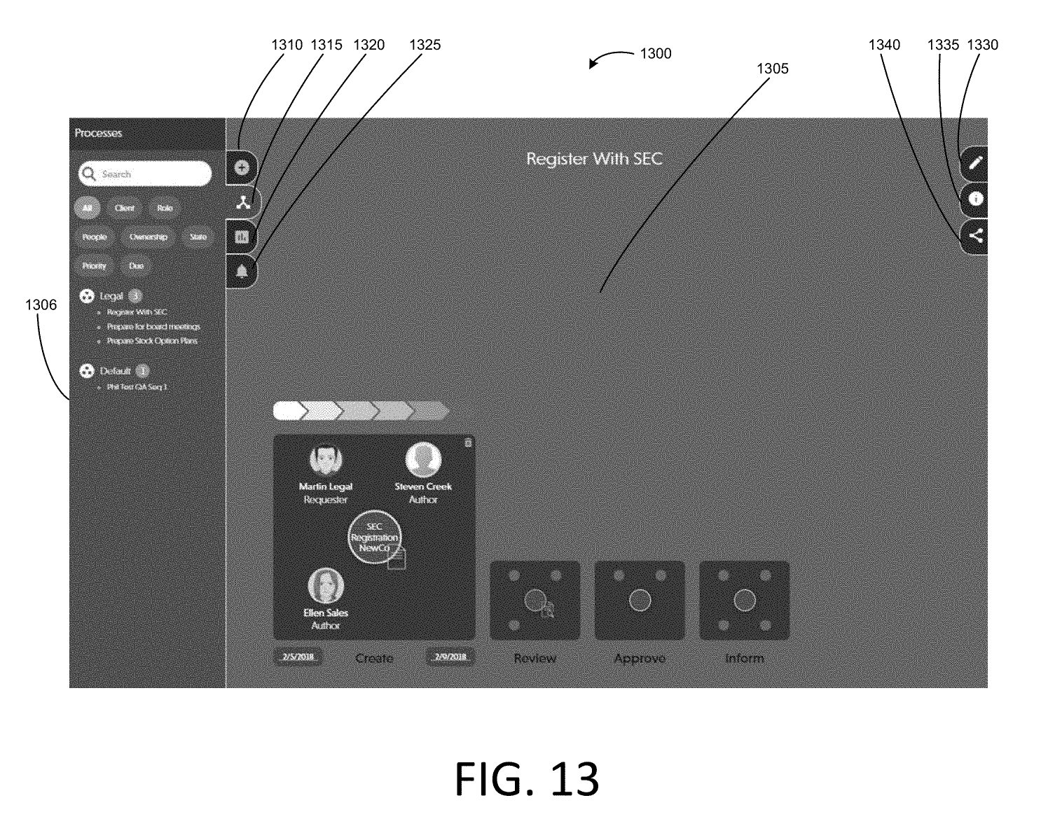

FIG. 13 is a screenshot of a GUI 1300 that facilitates management of microflows, consistent with various embodiments. In some embodiments, the GUI 1300 is generated by the PMT 105 of FIG. 1. The GUI 1300 generates a 2D representation of microflows, such as the 2D representations depicted in FIGS. 12A-12D, in a first portion 1305. The GUI 1300 includes a second portion 1306 that provides various options for managing the microflows. For example, the second portion includes a search bar that lets a user to search for a microflow or a process by a keyword, e.g., a name of the microflow, a process, a work artifact, a user, a role, a priority, due date. The second portion 1306 also provides various filters that can be used to filter the search results. The second portion 1306 can also present the processes organized under different departments. For example, processes associated with a legal department can be organized under the department name “Legal.”

The GUI 1300 also provides various GUI elements, e.g., GUI elements 1310-1340, that can be used to manage a microflow or a process. A create GUI element 1310 facilitates creation of a process or a microflow. A microflow GUI element 1315 allows the user to access a microflow GUI, such as the first portion 1305, which facilitates the user to access an existing process or a microflow.

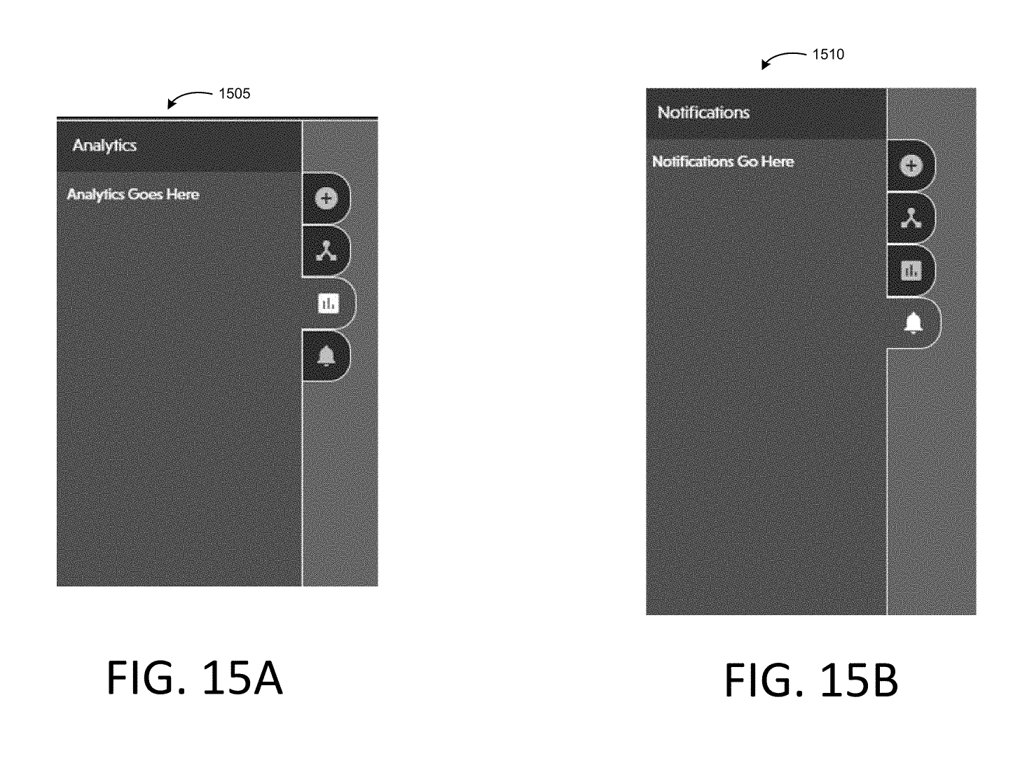

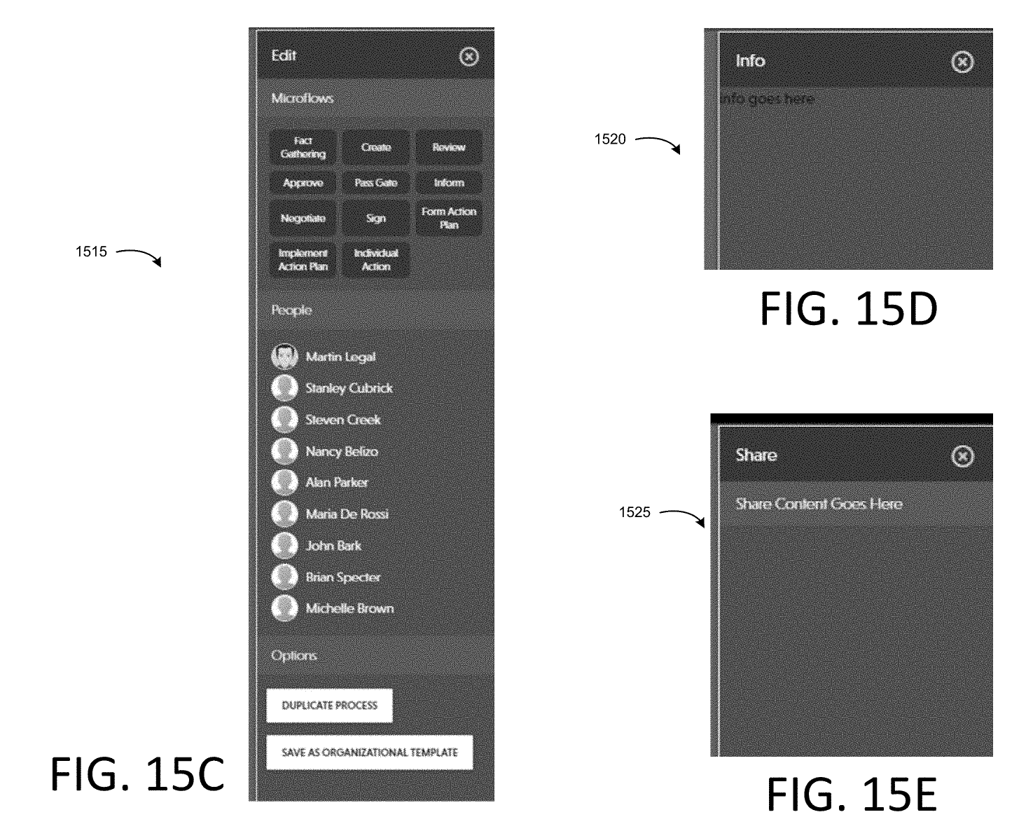

A metric GUI element 1320 facilitates viewing of various analytics metrics associated with a microflow or a process, e.g., in GUI 1505 of FIG. 15A. The PMT 105 may generate analytics based on the microflows or processes to determine best practices for learning, productivity, and efficiency. For instance, the PMT 105 may analyze data indicative of the performance of individuals or organizations. Additionally, microflows or processes can be analyzed as aggregated organizational graphs. The analysis provides an indication of the best practices by function or organization. For example, performance may be evaluated based upon time taken per microflow. The less time taken per microflow step, the higher the performance. The performance may be aggregated and distilled to identify productive people, microflows and processes. The PMT 105 may generate recommendations based upon the analytics to recommend enhanced microflows and processes based on improved combinations of work artifacts, actions, parties, and roles.

A notification GUI element 1325 facilitates accessing of notifications a user has received with respect to a process or a microflow, e.g., in GUI 1510 of FIG. 15B. The notifications can include information regarding the status or changes to a work artifact, microflow or a process. A notification may indicate that a person has not yet reviewed or edited a work artifact. A notification may be a reminder regarding a due date.

The edit GUI element 1330 allows a user to edit a microflow or a process. Upon selecting the edit GUI element 1330, the PMT 105 generates a GUI 1515 of FIG. 15C that provides various options for the user to manage a microflow or a process. For example, the user can add a microflow to an existing process by selecting a microflow from the “Microflows” section in the GUI 1515. In another example, the user can add a user to an existing microflow by selecting a user from the “People” section in the GUI 1515. The GUI 1515 also provides an option for the user to duplicate a process. For example, by selecting “Duplicate Process” option in the GUI 1515 the user can create another copy of a process. This can be beneficial in many cases, e.g., in a scenario where the user has to create a new process that is not significantly different from an existing process. The user can duplicate an existing process to create a copy and make any necessary changes to the copy to generate a new process. This can save the user from the time and effort required to create a new process that is not very different from an existing process.

A user may also store a microflow or a process as a template, which can be used by other users or by the user in generating new microflows or processes. Templates may be implemented that reflect the most common microflows in terms of roles and activities. A microflow may be instantiated based on a template. In other words, templates define actions and roles for a reoccurring task and microflows can be generated by instantiating a template. For example, a template for a create document microflow may associate a work artifact (e.g., a Word document) with a draft action, and the draft action may be associated with one or more parties typically responsible for drafting documents. In another example, a template may also be created for a review action that associates parties with supervisory authority to review and approve the work artifact. Templates allow users to quickly create typical microflows for common situations. Users may create, modify, or duplicate templates to suit their needs. A person skilled in the art will understand that other templates may be created to meet the needs of a reoccurring task situation.

An information GUI element 1335 allows a user to view various information associated with a process or a microflow, e.g., in GUI 1520 of FIG. 15D. The information can include a storage location of a microflow or a process, a name of the owner who created a microflow or a process, a file size of the microflow or a process on a storage device etc.

A sharing GUI element 1340 allows a user to share a microflow or a process with another user, e.g., in the GUI 1525 of FIG. 15E. The user may share the microflow or process with another user within a team or with a user from another team in an organization or to another user outside of the organization. The GUI 1525 can provide various ways to share a microflow, e.g., as attachment in an email or via a third-party messaging application or a social networking application. The PMT 105 may aggregate microflows and/or processes in a resource repository 125 of FIG. 1. The PMT 105 may also provide access to the resource repository 125 for the users. The PMT 105 may allow users to browse the repository to share, purchase and sell microflows and processes. By providing a repository that is accessible by the users, the PMT 105 may facilitate a marketplace to sell, purchase, and trade microflows and processes. The marketplace allows users to make available desirable microflows or processes for other users to purchase and implement. For example, desirable microflows and processes may be those that efficiently achieve common tasks or those that provide a unique way to achieve common tasks. The PMT marketplace may be used to support interest-driven communities as well as goal-oriented situational teams.

Users and organizations may provide their microflows and processes on the resource repository 125 to advertise their services. For example, a law firm may provide a microflow or process for generating legal document to the resource repository 125 for access by users, organizations, or other potential clients. The microflow or process may be used to present how the legal document is generated. By allowing users to view the microflow or process on the resource repository 125, the law firm may advertise services related to the generation of the legal document. Prospective clients gain more information about how the services are rendered and may be more inclined to retain the law firm for services. A person skilled in the art will understand that microflows and processes for other services may be presented to advertise services to prospective clients.

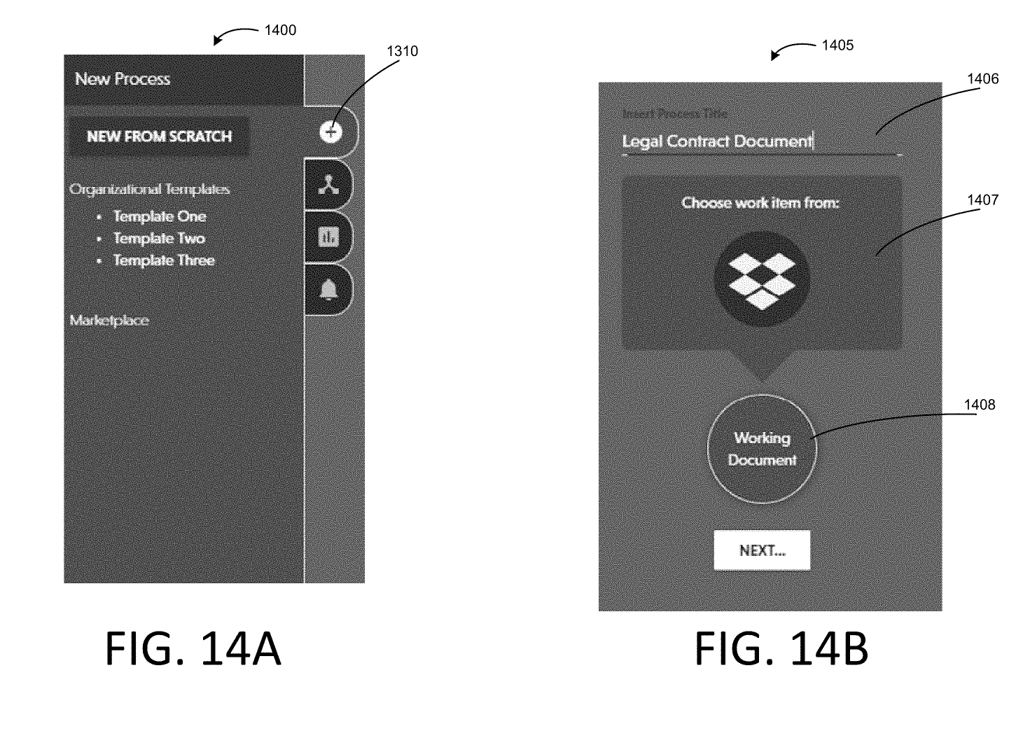

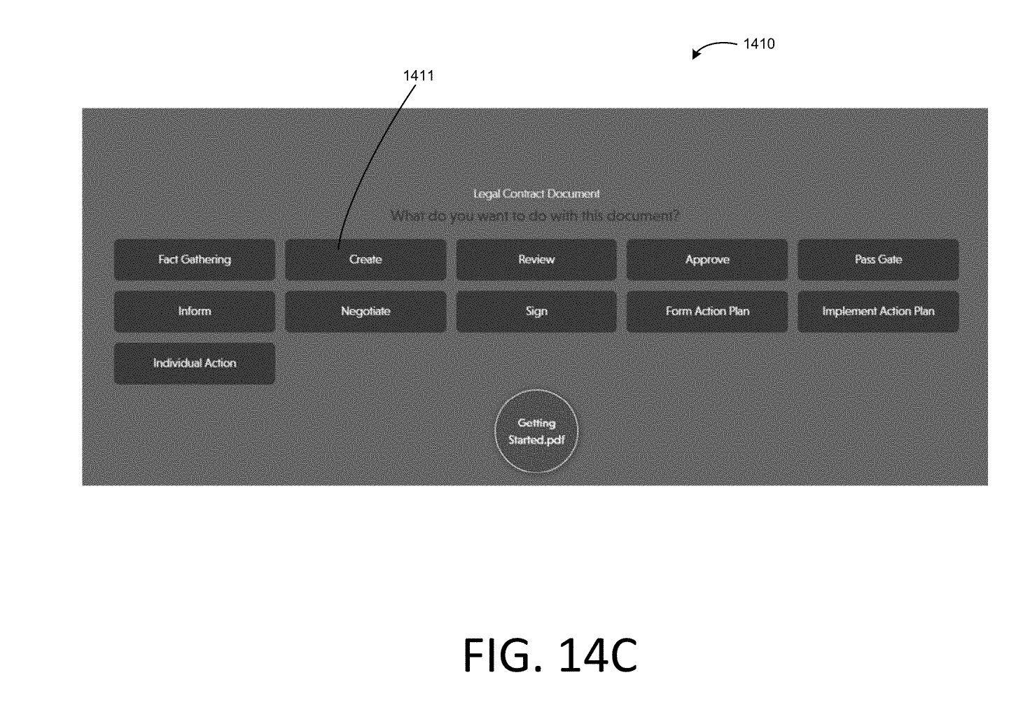

FIGS. 14A-14F are example screenshots of a GUI that facilitates manipulation of microflows, consistent with various embodiments. In some embodiments, the GUIs in FIGS. 14A-14F are generated by the PMT 105 of FIG. 1. FIG. 14A is an example screenshot of a GUI 1400 for creating a new process, consistent with various embodiments. A user can access the GUI 1400 by selecting the create GUI element 1310. In the GUI 1400, the user can start creating a new process by selecting the option “New from Scratch.” The user is then presented with the GUI 1405 of FIG. 14B which generates a set of GUI elements. For example, the GUI 1405 generates a first GUI element 1406, such as a data entry box, using which the user can enter the title of a process, e.g., “Legal Contract Document.” The GUI 1405 generates a second GUI element 1407 using which the user can choose a storage location, e.g., a file storage service, from which a work artifact 1408 is to be retrieved and associated with one or more microflows that are to be generated. In some embodiments, the work artifact 1408 is similar to the work artifact 155 of FIG. 1. The GUI 1405 shows only one file storage service, e.g., Dropbox, from which the document is to be retrieved. However, the PMT 105 can provide integration with multiple file storage services from which the user can retrieve the work artifact 1408. The user can also access the work artifact 1408 from a local storage device of a computer system using which the user is accessing the PMT 105.

In the GUI 1410 of FIG. 14C, the user can choose a microflow based on the collaboration task to be performed on the work artifact 1408. For example, if the collaborative task to be performed is creating the legal contract document, the user may choose “create” microflow 1411. After the user chooses the create microflow 1411, the user is navigated to a microflow GUI such as the first portion 1305 in the GUI 1300 of FIG. 13. The user can add, remove, or change users within the create microflow 1411 using edit GUI element 1330, and/or set or change roles of the users, e.g., using menu 1252 of FIG. 12B.

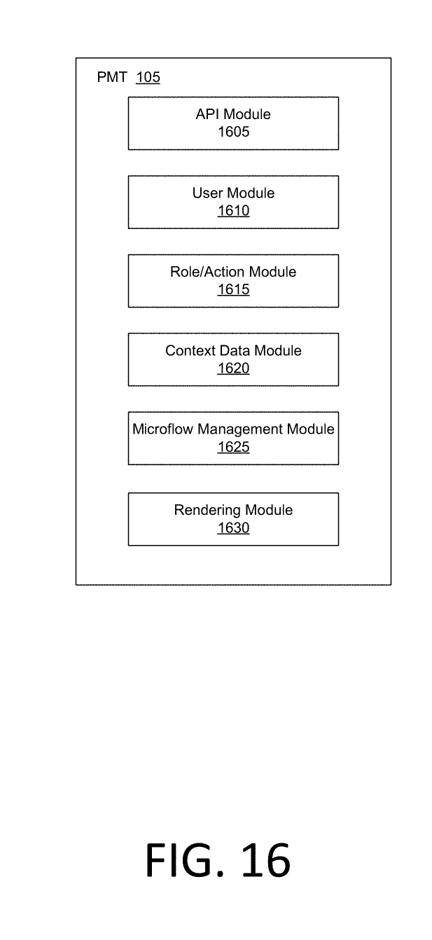

FIG. 16 is a block diagram illustrating an architecture of the PMT of FIG. 1, consistent with various embodiments. In some embodiments, the PMT 105 is implemented as an application executing on a server computing device. In some embodiments, the PMT 105 may be launched remotely by a user and executed on a cloud-based service. Alternatively, the PMT 105 may also be executed on a local computer system associated with the user. The PMT 105 facilitates collaboration on a work artifact, such as work artifact 155 of FIG. 1, by multiple parties.

The PMT 105 includes an application programming module (API) module 1605 that integrates the PMT with various applications, services, or systems. For example, the API module 1605 may integrate the PMT 105 with various file sharing services, e.g., Dropbox, Box, Google Drive, to obtain the work artifact from. The API module 1605 uses credentials to the file sharing service and directly accesses the work artifact stored in the file sharing service. Thus, the user may not need to directly share access to the file sharing service. The API module 1605 may integrate the PMT 105 with various systems including customer relationship management (CRM) systems, human capital management (HCM) systems, IT Ops Management (ITOM) systems, supply chain management (SCM) systems, enterprise resource planning (ERP) systems, other business process model and notation (BPMN) systems, cloud hosting services, software as a service (SaaS), platform as a service (PaaS), Infrastructure as a Service (IaaS), etc. By providing integration with various third-party systems and/or services, the PMT 105 enables management of processes or microflows in various industries or application areas.

The PMT 105 can also provide an API framework using which an organization can customize the APIs provided by the PMT 105 to integrate the PMT 105 with their existing systems and/or applications. The API framework can also be used by a third-party vendor to customize the APIs provided by the PMT 105 for a particular customer/organization. Further, using the API framework, the third-party vendor can also build additional or new APIs to integrate the PMT 105 with various types of applications, e.g., applications for which the PMT 105 does not already provide an API.

The PMT 105 includes a user module 1610 the facilitates user management in the microflows and/or processes. The user module 1610 provides an interface to user profile repository 126 in the resource repository 125 which has information regarding users in an organization. The user module 1610 also facilitates adding or removing of a user in a microflow.

The PMT 105 includes a role/action module 1615 that facilitates designation of roles to a user in a microflow or actions to the work artifact 155 in the microflow.

The PMT 105 includes context data module 1620 that manages contextual information associated with the work artifact 155. The context data module 1620 can generate a context data object, e.g., context data object 505 of FIG. 5, that stores context information such as relationship between the work artifact 155, actions associated with the work artifact 155 and the users associated with those actions. The context information can also be used to generate various metrics associated with a microflow and/or a process.

The PMT includes a microflow management module 1625 that facilitates management of microflows. For example, the microflow management module 1625 facilitates creation and execution of a microflow and/or a process based on the context information associated with the work artifact 155.

The PMT includes a rendering module 1630 that generates an interactive graphical representation of a microflow and/or a process, such as the ones described at least with reference to FIGS. 6-15. PMT 3D objects, and translator. Using the interactive graphical representation, the user can visualize, create, and/or manipulate a microflow or the process. The interactive graphical representation can be a 3D graphical representation or a 2D graphical representation. The 3D representation may also be virtual reality (VR) or augmented reality (AR) based.

Further, the PMT 105 can be implemented as an application/service executing on cloud-computing resources. The cloud computing resources can be part of a public cloud, a private cloud, or a hybrid cloud. The PMT 105 can be accessed through a web server. The PMT 105 can be implemented as a browser based application or as an app. The user can access the browser-based PMT 105 via a web browser installed on a computing device associated with the user. The app-based PMT 105 can be accessed using an app installed on the computing device associated with the user. The PMT can be accessed using a variety of computing devices, such as a desktop, a laptop, a smartphone, a tablet PC, and a wearable device.

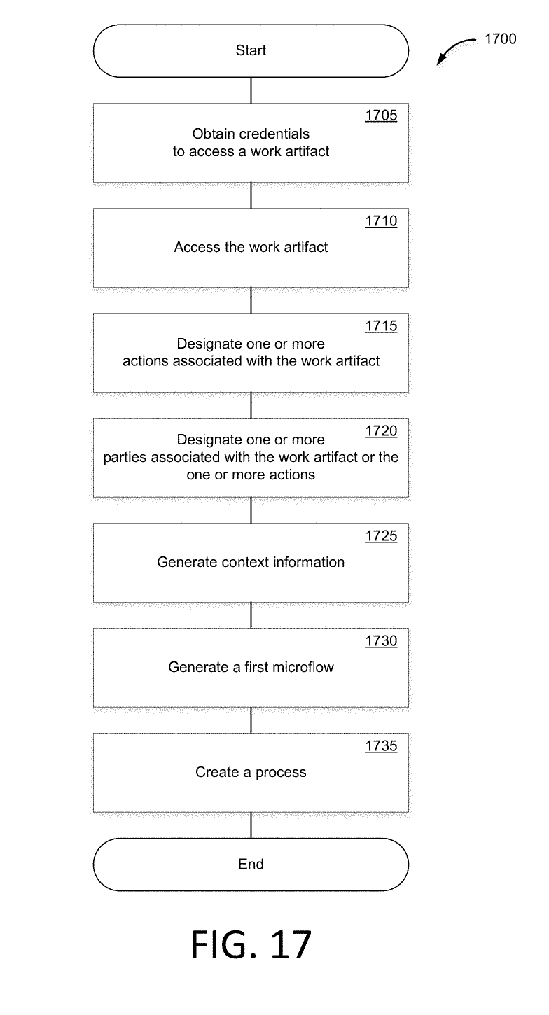

FIG. 17 is a flow diagram of a method for creating a process, consistent with various embodiments. In some embodiments, the method 1700 may be implemented in the environment 100 of FIG. 1, e.g., using the PMT 105. At block 1705, the API module 1605 obtains a credential to access a work artifact, e.g., the work artifact 155. The work artifact can be stored in a remote storage location, e.g., a file sharing service such as Box or Dropbox, and the credentials can include login credentials for the file sharing service such as username and password.

At block 1710, the API module 1605 retrieves the work artifact associated with the obtained credential. Note that more than one work artifact can be associated with a microflow and can be obtained from the same storage location or different storage locations.

At block 1715, the role/action module 1615 designates one or more actions associated with the work artifact. An action can be any of the actions that are to be performed for achieving a goal of a specified collaborative task. Examples of an action include create, review, watch, negotiate, and inform.

At block 1720, the user module 1610 associates one or more users with the one or more actions. For example, if the work artifact is associated with two actions, a first user may be associated with a first action and a second and third user may be associated with a second action.

Note that the work artifact may be associated with role-based users instead of being associated with actions and then the actions with the users. In such a case, the work artifact is associated with a user and the user is associated with a specified role for performing the collaborative task. For example, the work artifact may be associated with a first user and the first user may associated with role of an “author” to create the work artifact.

At block 1725, the context data module 1620 generates context information that indicates the relationship between the work artifact, the actions, and the users.

At block 1730, the microflow management module 1625 generates a first microflow based on the context information. The first microflow corresponds to the specified collaborative task and represents the work artifact, the actions, and the users associated with specified collaborative task.

At block 1735, the microflow management module 1625 creates a process by associating the work artifact or the one or more associated parties across the first microflow and at least a second microflow. The second microflow may correspond to another collaborative task to be performed in association with the work artifact. The second microflow may be created like the first microflow as described at least with reference to blocks 1705-1730. The process may be a combination of multiple collaborative tasks in which each of the collaborative tasks is performed by at least one of the microflows. Note that, in some embodiments, when a second microflow is created, the context information of the work artifact, which already exists for the first microflow, is updated with the information of the second microflow instead of creating a new context data object. A person skilled in the art will understand that steps may be added or removed in various embodiments of the invention. Additionally, a person skilled in the art will understand that the steps may be performed in different orders.

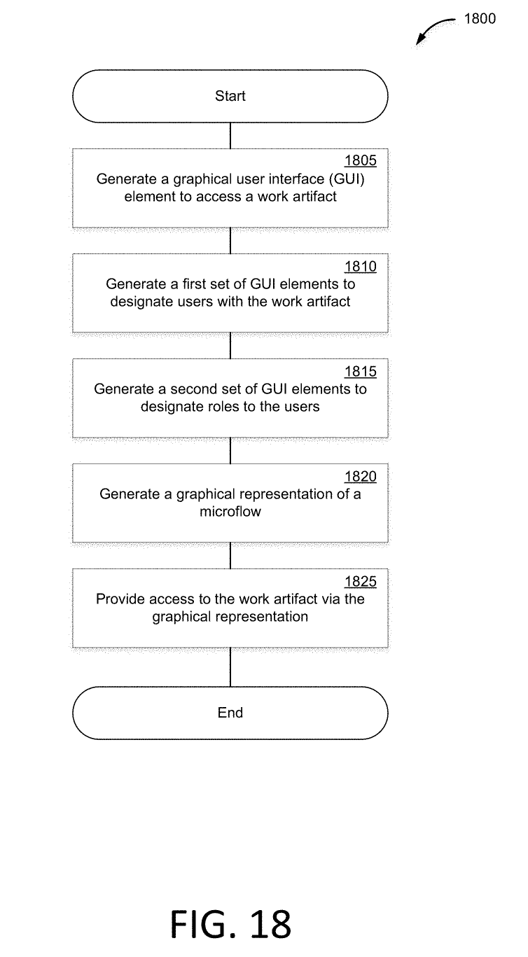

FIG. 18 is a flow diagram of a method for generating a graphical representation of a microflow or a process, consistent with various embodiments. In some embodiments, the method 1800 can be implemented in the environment 100 of FIG. 1 and executed by the PMT 105. At block 1805, the rendering module 1630 generates one or more GUI elements using which a user can access a work artifact from a storage location of the work artifact. For example, the one or more GUI elements can be similar to the GUI element 810 of FIG. 8, the 3D representation 926 of FIG. 9, or GUI element 1407 of FIG. 14B. In some embodiments, the work artifact is similar to the work artifact 155 of FIG. 1.

At block 1810, the rendering module 1630 generates a first set of GUI elements to designate multiple users associated with the work artifact. For example, the first set of GUI elements can be similar to the GUI element 815 of FIG. 8 or GUI elements in GUI 1515 of FIG. 15C.

At block 1815, the rendering module 1630 generates a second set of GUI elements to set the role of the users. For example, the second set of GUI elements can be similar to the menu 1252 of FIG. 12B.

At block 1820, the rendering module 1630 generates a graphical representation of a microflow. The graphical representation can be a 2D representation or a 3D representation of the microflow. The first microflow corresponds to a particular collaboration task to be performed on the work artifact by the users designated in block 1810. In some embodiments, the graphical representation of the microflow is similar to the graphical representation of create document microflow 605 of FIG. 6, approve document microflow 705 of FIG. 7, review microflow 910 of FIG. 9, or create microflow 1210 of FIG. 12A.

At block 1825, the rendering module 1630 provides access to the work artifact to the users via the graphical representation of the microflow for performing the particular collaboration task. For example, in the graphical representation of the create microflow 1210, a user can select the work artifact 1226, e.g., a document, to open, view and/or edit the document.

Note that, in some embodiments, the rendering module 1630 can have multiple sub-modules and the functions described above in the method 1800 can be performed by different sub-modules of the rendering module 1630.

Although the PMT 105 is described with respect to generating microflows for a business process, e.g., creating a legal contract document, or registering a business entity with a government agency, the PMT 105 can be implemented for any process in general, and is not limited to a business process. For example, the PMT 105 can be implemented for managing a patient lifecycle in a hospital. The PMT 105 can provide a 3D representation of a patient going through various stages, e.g., the patient arriving at a reception desk, then visiting a diagnostic department, then visiting a lab, e.g., for MRI, then to a hospital bed, and then leaving the hospital upon discharge. One or more of the above stages can be represented as microflows of a process. The 3D representation of the process can also depict post analysis stage of the patient. A user, e.g., care personnel such as a doctor, a nurse, and/or a lab expert, can visualize, create, and/or manipulate the patient lifecycle process, or at least a part of it, from the 3D representation generated by the PMT 105. Further, the PMT 105 can enable the user to view data such as what was the experience of the patient in each of the stages, what were the issues, etc. The PMT 105 can provide a virtual 3D representation of the hospital, which depicts various entities such as departments, personnel of the hospital, teams of the hospital, and/or equipment in the hospital. The user can select any of the entities, e.g., using gestures, mouse clicks, in the 3D representation and view data associated with the corresponding entity and/or also perform one or more functions associated with corresponding entity.

Typically, the PMT 105 can be used for any kind of consumer/private scenarios as well, wherever there is the need to coordinate “who does what, when and how,” e.g., “soccer moms”.

In some embodiments, to facilitate articulating and/or manipulating various types of data in a process, the PMT 105 can be integrated with various backend systems, e.g., CRM system, HCM system, SCM system, CMS, ERP system, cloud-storage services, cloud-computing services, etc. These systems can be provided by a third party, and can be integrated with the PMT 105 using the APIs provided by the PMT 105 and/or the backend systems. The PMT 105 obtains the data from the backend systems using the APIs, and presents the data in a 3D representation. For example, the API can include data objects and/or object libraries that connect the process in the backend system to the 3D visualization by obtaining the data from the process, converting it to format that can be presented in a 3D view, and generating the 3D representation for visualizing the converted data.

The PMT also allows reflecting, displaying and enabling different human psychology/work styles or types. The work styles are considered to bring useful perspectives and distinctive approaches to generating ideas, making decisions, and solving problems. Some known work styles include “Pioneers,” “Guardians,” “Drivers” and “Integrators.” Pioneers are believed to value possibilities, spark energy and imagination on their teams and are drawn to bold new ideas and creative approaches. Guardians are believed to value stability, and bring order and rigor. Drivers are believed to value challenge, generate momentum, tackle problems head on, armed with logic and data. Integrators are believed to value connection, draw teams together, tend to believe that most things are relative and focused on gaining consensus. The work styles or types can be determined using the various metrics associated with the microflows or processes. Similar to the 3D visualization, the ability to reflect, display and/or enable work styles and types can deliver significant productivity benefits to the users of the PMT 105. In some embodiments, the PMT 105 uses machine learning techniques and/or artificial intelligence (AI) to identify work patterns to help people discover their work types.

In some embodiments, the PMT 105 can also be used to work with a “flow,” e.g., a people process. In some embodiments, people processes are different to those automated in existing business process applications, in that the people processes are more semi-structured and dynamic, and they organize and coordinate the day-to-day who does what, as seen by the actual people themselves. Being able to visualize these processes and relationships, and being able to instantly see the status and progress using the PMT 105, provides a significant productivity benefit to an individual and/or team. In addition, as these processes are captured, the PMT 105 can generate structured reports that highlight the throughput or flow of the processes and/or sub-steps in them. As a result of these reports and diagnostics, it will be possible to increase learning and innovation on this people level significantly, with the direct feedback being fed back into changed process flows.

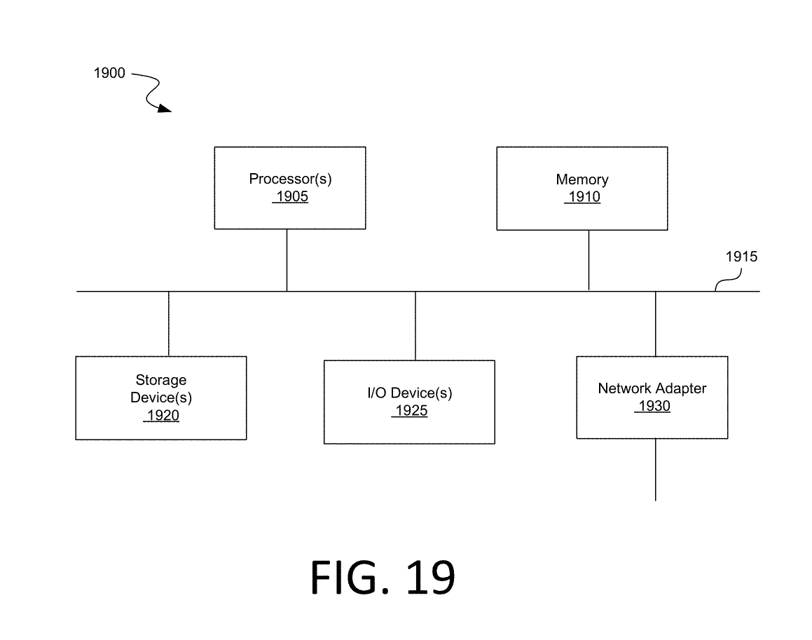

FIG. 19 is a block diagram of a computer system as may be used to implement features of the disclosed embodiments. The computing system 1900 may be used to implement any of the entities, components, modules, systems, or services depicted in the examples of the foregoing figures (and any other entities described in this specification). The computing system 1900 may include one or more central processing units (“processors”) 1905, memory 1910, input/output devices 1925 (e.g., keyboard and pointing devices, display devices), storage devices 1920 (e.g., disk drives), and network adapters 1930 (e.g., network interfaces) that are connected to an interconnect 1915. The interconnect 1915 is illustrated as an abstraction that represents any one or more separate physical buses, point to point connections, or both connected by appropriate bridges, adapters, or controllers. The interconnect 1915, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 1910 and storage devices 1920 are computer-readable storage media that may store instructions that implement at least portions of the described embodiments. In addition, the data structures and message structures may be stored or transmitted via a data transmission medium, such as a signal on a communications link. Various communications links may be used, such as the Internet, a local area network, a wide area network, or a point-to-point dial-up connection. Thus, computer readable media can include computer-readable storage media (e.g., “non-transitory” media).

The instructions stored in memory 1910 can be implemented as software and/or firmware to program the processor(s) 1905 to carry out actions described above. In some embodiments, such software or firmware may be initially provided to the processing system 1900 by downloading it from a remote system through the computing system 1900 (e.g., via network adapter 1930).

The embodiments introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more application-specific integrated circuits (ASICs), programmable logic device (PLDs), field-programmable gate array (FPGAs), etc.

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments. Accordingly, the embodiments are not limited except as by the appended claims.

Reference in this specification to “one embodiment” or “an embodiment” means that a specified feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Terms that are used to describe the disclosure are discussed below, or elsewhere in the specification, to provide additional guidance to the practitioner regarding the description of the disclosure. For convenience, some terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for some terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Those skilled in the art will appreciate that the logic illustrated in each of the flow diagrams discussed above, may be altered in various ways. For example, the order of the logic may be rearranged, substeps may be performed in parallel, illustrated logic may be omitted; other logic may be included, etc.

Without intent to further limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

I/we claim:

1. A method performed by a computing system, comprising:
generating a first graphical user interface (GUI) element to retrieve a work artifact from a storage location of the work artifact;
generating a set of GUI elements to designate multiple parties associated with the work artifact, wherein the multiple parties include a first party that is associated with a first role to perform a first task associated with the work artifact;
generating a graphical representation of a first microflow that allows the first party to perform the first task, the first microflow associated with context information indicating relationship between the work artifact and one or more of the multiple parties; and
providing access to the work artifact to the first party via the graphical representation of the first microflow for performing the first task.

2. The method of claim 1 further comprising:
generating, at the computer system, a process by associating the work artifact across the first microflow and a second microflow, the second microflow for performing a second task associated with the work artifact, the process being a collection of tasks associated with the work artifact; and
generating a graphical representation of the process that allows a user to manage the microflows.

3. The method of claim 2, wherein generating the graphical representation of the process generating a three-dimensional (3D) graphical representation of the microflows.

4. The method of claim 3, wherein generating the 3D graphical representation includes generating a virtual 3D graphical representation of the microflows.

5. The method of claim 2, wherein generating the graphical representation of the process includes generating a two-dimensional (2D) graphical representation of the microflows.

6. The method of claim 2, wherein generating the graphical representation of the process includes:
determining a current microflow of the process that is under progress based on the context information, and
presenting a graphical representation of the current microflow.

7. The method of claim 2, wherein generating the first microflow includes:
determining a status of the first task,
determining if the status indicates that the first task is completed, and
in response to a determination that the first task is completed, generating a graphical representation of the second microflow to allow one or more of the multiple parties to perform the second task.

8. The method of claim 1, wherein generating the graphical representation of the first microflow includes generating a graphical representation of the work artifact and the one or more of the multiple parties.

9. The method of claim 1, wherein generating the first GUI element includes:
generating a graphical representation of the storage location of the work artifact, the storage location being a file sharing service that is independent of the computing system.

10. The method of claim 1, wherein generating the first GUI element includes:
receiving a user input via the graphical representation of the storage location, the user input including access credentials of the user for the storage location,
retrieving the work artifact from the storage location, and
generating the graphical representation of the work artifact in the first microflow for access by the first party.

11. The method of claim 1, wherein providing access to the work artifact includes:
receiving, via the graphical representation of the work artifact, a request from the first party for performing the first task associated with the work artifact, and
updating the work artifact as a result of the first task to generate an updated work artifact.

12. The method of claim 1, wherein generating the graphical representation of the first microflow includes:
generating a graphical representation of a building in which the one or more parties are located.

13. The method of claim 12, wherein generating the graphical representation of the first microflow includes:
determining a location of the first party in the building, and generating a graphical representation of a portion of the building in which the first party is located.

14. The method of claim 13, wherein determining the location includes:
determining the location based on a Wi-Fi hotspot signal in the building with which a user device of the first party is communicating.

15. The method of claim 1, wherein generating the graphical representation of the first microflow includes:
generating a graphical representation of a desk,
receiving a user input to move the work artifact to the desk,
in response to moving the work artifact to the desk, generating an invitation to invite one or more of the multiple parties for a meeting,
receiving a user selection of the one or more of the multiple parties, wherein the user selects the one or more of the multiple parties by selecting a graphical representation of the corresponding one or more multiple parties, and
sending the invitation to the one or more of the multiple parties.

16. The method of claim 1 further comprising:
generating a graphical representation of a display device, and
displaying multiple metrics associated with the first microflow in the graphical representation of the display device.

17. A computer-readable storage medium storing computer-readable instructions for executing by a computing system, comprising:
instructions for generating a first graphical user interface (GUI) element to retrieve a work artifact from a file sharing service;
instructions for generating a set of GUI elements to designate multiple parties associated with the work artifact, wherein the multiple parties are associated with different roles for performing multiple collaborative tasks associated with the work artifact;
instructions for generating a graphical representation of a process that allows one or more of the multiple parties to manage multiple microflows of the process for performing the multiple collaborative tasks, wherein the multiple microflows includes a first microflow and a second microflow, the first microflow generated by associating the work artifact with a first set of parties of the multiple parties to perform a first task of the multiple collaborative tasks, the second microflow generated by associating the work artifact with a second set of parties of the multiple parties to perform a second task of the multiple collaborative tasks, wherein each of the microflows is associated with context information that indicates relationship between the work artifact and one or more of the multiple parties for the corresponding microflow; and
instructions for providing access to the work artifact to the first party via the graphical representation of the process for performing the first task.

18. The computer-readable storage medium of claim 17, wherein the instructions for generating the graphical representation of the process include:
instructions for generating a 3D graphical representation of the microflows that allows the first party to navigate to any of the microflows and perform one or more of the collaborative tasks.

19. The computer-readable storage medium of claim 18, wherein the instructions for generating the 3D graphical representation include:
instructions for generating a 3D graphical representation of the work artifact and one or more of the multiple parties associated with the work artifact in the first microflow.

20. The computer-readable storage medium of claim 18, wherein the instructions for generating the 3D graphical representation include:
instructions for generating a 3D graphical representation of a physical space in which the first party performs the first task.

21. The computer-readable storage medium of claim 20, wherein the instructions for generating the 3D graphical representation of the physical space include:
instructions for generating a 3D graphical representation of different perspectives of the physical space.

22. The computer-readable storage medium of claim 17, wherein generating the first GUI element includes:
instructions for receiving a user input via the graphical representation of the file sharing service, the user input including access credentials of the user for the file sharing service,
instructions for retrieving the work artifact from the file sharing service, and
instructions for generating the graphical representation of the work artifact in a graphical representation of the first microflow for access by the first party.

23. The computer-readable storage medium of claim 17, wherein providing access to the work artifact includes:
instructions for receiving, via the graphical representation of the work artifact, a request from the first party for performing the first task associated with the work artifact, and
instructions for updating the work artifact as a result of the first task to generate an updated work artifact.

24. The computer-readable storage medium of claim 17, wherein generating the first microflow includes:
instructions for determining a status of the first task,
instructions for determining if the status indicates that the first task is completed, and
in response to a determination that the first task is completed, instructions for generating a graphical representation of the second microflow to allow one or more of the multiple parties to perform the second task.

25. The computer-readable storage medium of claim 17 further comprising:
instructions for determining a set of microflows or processes the first party is associated with based on context information associated with the set of microflows or processes, and
instructions for generating information regarding the set of microflows or processes on a display device associated with the first party.

26. The computer-readable storage medium of claim 25 further comprising:
instructions for receiving a user selection of a specified microflow from the set of microflows, and
instructions for generating a graphical representation of the specified microflow having a specified work artifact and a specified set of parties associated with the specified microflow, wherein the specified work artifact and the specified set of parties are determined using context information associated with the specified microflow.

27. The computer-readable storage medium of claim 15, wherein the instructions for generating information regarding the set of microflows or processes include:
instructions for generating a set of notifications associated with the first party, the notifications including reminders for tasks to be performed by the first party in the set of microflows or processes.

28. A system, comprising:
a first component to generate a first graphical user interface (GUI) element to retrieve a work artifact from a file sharing service;
a second component to generate a set of GUI elements to designate multiple parties associated with the work artifact, wherein the multiple parties are associated with different roles for performing multiple collaborative tasks associated with the work artifact;
a third component to generate a graphical representation of a process that allows one or more of the multiple parties to manage multiple microflows of the process for performing the multiple collaborative tasks, wherein the multiple microflows includes a first microflow and a second microflow, the first microflow generated by associating the work artifact with a first set of parties of the multiple parties to perform a first task of the multiple collaborative tasks, the second microflow generated by associating the work artifact with a second set of parties of the multiple parties to perform a second task of the multiple collaborative tasks, wherein each of the microflows is associated with context information that indicates relationship between the work artifact and one or more of the multiple parties for the corresponding microflow; and
a fourth component to provide access to the work artifact to the first party via the graphical representation of the process for performing the first task.
